(19) United States
(12) Patent Application Publication
(10) Pub. No.: US 2004/0158355 A1
(43) Pub. Date: Aug. 12, 2004

(54) Intelligent methods, functions and apparatus for load handling and transportation mobile robots

(76) Inventors: Hans Robert Holmqvist, Kungsbacka (SE); Hans Goran Seger, Goteborg (SE)

Correspondence Address: ARNEX NAVIGATION SYSTEMS AB, STORA BADHUSGATAN 16, GOTEBORG, S-41121, SE

(21) Appl. No.: 10/748,207

(22) Filed: Dec. 31, 2003

(30) Foreign Application Priority Data
Jan. 2, 2003 (SE) 0300001-5

(51) Int. Cl. G06F 19/00

(52) U.S. Cl. 700/245; 701/23

(57) ABSTRACT

Disclosed are intelligent systems and functions for autonomous load handling vehicles such as wheel-loaders operating within limited areas and industrial environments. The vehicle is provided with a laser-optic system for determining the vehicle's position in six degrees of freedom comprising x, y, z, heading, pitch and roll, in fixed to ground coordinates. This system is used for autonomous vehicle navigation and as reference for on board terrain mapping sensors and a dynamic terrain model. The admitted work area for autonomous vehicle operation is divided in loading, unloading and obstacle free zones, each with specific rules for the vehicle's behaviour concerning, mission planning, vehicle and implement movement and control, and obstacle detection and avoidance. The dynamic terrain model is employed for planning and analysing paths, for detecting and avoiding obstacles, and for providing data for optimizing vehicle paths and the movements of its implements in loading and unloading operations.

### CROSS-REFERENCE TO RELATED APPLICATIONS

This patent application claims the benefit of the prior Swedish patent application N:o 0300001-5, filed Jan. 2, 2003, for the same invention

### BACKGROUND OF THE INVENTION

The invention relates generally to intelligent methods, functions and apparatus for mobile robots in the form of autonomous vehicles and machines for load handling and transportation, based on laser-optic sensors for position determination and mapping of terrain, material volumes and other handling objects, obstacle detection and vehicle and implement control in loading and unloading operations.

Autonomous vehicles for handling and transportation of goods are widely used in indoor industrial applications such as factory and warehouse logistics. Intelligent functions such as handling objects recognition and loading normally require palletised or otherwise standardised packaging. There is a need for intelligent autonomous vehicle handling and transportation functions also for bulk material such as heavy chemical and mineral products in indoor as well as outdoor applications. For other outdoor applications such as large scale earthmoving in mining and excavation, there is an increasing demand for autonomous excavators, front shovels and the like. In this field, there exists solutions based on electro-optic sensors and satellite navigation systems for recognising and acquiring bulk material such as minerals, ores and gravel.

In less extensive industrial applications, such as handling of solid fuels like biomass and coal and other products from forest and agriculture, there is a need for reliable, accurate, and cost effective technology. For these applications, the present technology for the extensive outdoor applications has some severe limitations. Many intelligent functions, such as navigation and handling object recognition and loading, are very dependent upon the continuous availability of accurate, real time, position determination information. Satellite position determination systems and its radio communication might get lost near buildings or through building walls. In order to back up satellite navigation, additional support technologies have to be installed on the vehicles and in the local environment such as inertial navigation systems and earthbound satellite transmitters, which leads to complicated and expensive system solutions at the risk of degraded reliability. The accuracy in position determination, particularly concerning the vertical “z” dimension and the pitch and roll angles of the present outdoor earthmoving technology is also not sufficient for controlling loading operations where the z-coordinate of material volume and the underlying ground surfaces is of great importance. Thus there is a need for a more accurate, practical and simple single system solution for main autonomous vehicle intelligent functions such as work area and mission planning and control, navigation, material volume acquisition and obstacle detection and suitable for limited industrial sites that works well in outdoor as well as indoor or mining environments.

The publication No. WO 87/02484 from 1987 mentions a driverless vehicle having a certain capability for autonomous loading and unloading of singular solid objects. The method requires each handling object to be provided with a number of reflectors. It is also required that the objects are made in standardised measures. The method is not capable of bulk material loading or loading solid objects of varying and unknown shape.

In U.S. Pat. No. 5,548,516 from 1996 a driverless vehicle is described. This vehicle is capable of autonomous navigation based on GPS, inertial navigation and odometer based dead reckoning and it is equipped with a scanning laser rangefinder for obstacle detection and avoidance. The system has no dynamic terrain model and is lacking functions for autonomous material handling.

In a US research report:“Motion Planning for All-Terrain Vehicles: A Physical Modeling Approach for Coping with Dynamic and Contact Interaction Constraints”, IEEE Transactions on Robotics and Automation, Vol 15, No 2, April 1999, a path planning concept is presented for a mobile robot moving in unlimited terrain. The concept is based on full a priori knowledge of the terrain topology, and problems related to material and load handling are not treated in this work.

Neither is load handling and transportation treated in another research publication, Autonomous Robot Navigation in Unknown Terrains: Incidental Learning and Environmental Exploration”, IEEE Transactions on Systems, Man and Cybernetics, Vol 20, No 6, November/December 1990. This paper primarily deals with the problem of how to map the environment by means of a vehicle based terrain sensor.

In U.S. Pat. 5,974,352 a method is given for controlling a bucket by means of sensors for lift and tilt cylinder position and pressure, and how to optimize bucket lift and tilt movements based on integration of forces and movements in the load handling implement. The method requires an on board human operator for selecting loading point and for driving the vehicle to and from this point and who drives the vehicle in the entire loading movement and controls the bucket in the initial and final phases of the loading movement.

In U.S. Pat. No. 6,173,215 methods are given for autonomous navigation of a vehicle upon detecting an obstacle. Obstacle detections are only handled in a fixed to vehicle coordinate system and in real time and not recorded in a fixed to ground coordinate system in order to be considered in the forthcoming path.

In U.S. Pat. No. 6,223,110 B1, a software architecture is given for autonomous earthmoving machinery. The described application is centered around digging and excavation, and applications such as wheel loaders are only mentioned but not dealt with in any further detail. There is no reference to any work concerning how to solve the position determination problems especially concerning the z-coordinate in limited industrial environments, or how to measure, with satisfactory accuracy, the shape, volume and position of material volumes and other general handling objects in such environments. The problem of how to efficiently load and unload, with an autonomous vehicle, industrial products temporarily stored on surfaces that may not be horisontal or how to organise work in a limited areas is thus not dealt with in the patent or in its referenced publications.

Accordingly, the present invention is directed to overcome one or more of the problems set forth above.

### BRIEF SUMMARY OF THE INVENTION

This invention solves some of the above presented problems, in autonomous vehicles and machines with load handling implements and systems for autonomous navigation within limited sites, by defining for such a site a number of well defined zones for loading, unloading and autonomous navigation, by means of establishing a dynamic terrain model for the worksite, including a layer defining each type of zone, and, in addition, layers for reference ground surface, a best estimate of total terrain surface and a developing terrain surface estimate by employing a simple and cost effective system with a few on board sensors for vehicle position determination and terrain surface measurement, where the principal elements of this system comprise a combination of a scanning laser rangefinder and an on board vehicle six degrees of freedom laser-optic position determination system, where a specific DTM (dynamic terrain model) computer analyses current measurements with respect to existing model values and thereby is able to detect and with high accuracy record and analyse the surface of terrain, material volumes, general handling objects and obstacles in the present position and predicted path of the vehicle, where the position determination system determines the position of the vehicle and the scanning laser rangefinder in three dimensions and six degrees of freedom in a fixed to ground coordinate system and in addition provides position data for the steering control of the vehicle and also enables the continuous creation and updating of the above mentioned dynamic terrain model to be unambiguously performed in a fixed to ground coordinate system, and whereto a specific on board vehicle mission computer, based upon attack point and loading height profile data in a loading operation or bucket emptying point in an unloading operation from the DTM computer, this mission computer optimizes necessary parameters for the vehicle's path and the load handling implement's movements during approach, loading paths or unloading movements in an unloading operation, and where this mission computer also coordinates and demands vehicle path and implement movements both in previously fully planned and therefore static paths and movements as well as in the dynamically planned paths and movements the parameters of which have been calculated in the mission computer based on the analyses in the DTM computer.

### BRIEF DESCRIPTION OF THE SEVERAL VIEWS OF THE DRAWINGS

FIG. 1: Concepts tree. Relations between the concepts of driverless and autonomous and, in addition, preplanned versus intelligent and subconcepts to the latter.

FIG. 2: Load handling and transportation autonomous vehicle 1 with load handling implement 14 and bucket 142, scanning laser rangefinder 81 for measuring the position of points on terrain surface, material volumes and obstacles for providing input data to the on board dynamic terrain model. Position determination system 7 with onboard rotating laser-optic sensor 71 and suitable groundbased reflectors 72. The figure displays, in a vertical section, a laser ray being reflected by a material volume 181 and measuring the position of point P located in front of the vehicle 1.

FIG. 3: Principles for a laser-optic position determination system according to Swedish patent nr 464 837 for determining, in a fixed to ground coordinate system 41, the position of a vehicle 1 in three dimensions along with its heading, pitch and roll angles from angular measurements in a fixed to vehicle coordinate system 42 to a number of fixed to ground reflectors 72 within range of the rotating laser-optic sensor 71.

FIG. 4: Determining the 3D position (X, Y, Z), in a fixed to ground coordinate system 41, of points on the surface of terrain, material volumes and obstacles, from an arbitrarily positioned and oriented vehicle 1 employing an on-board scanning laser rangefinder 81 measuring in a fixed to vehicle coordinate system 42.

FIG. 5: Terrain map, from a dynamic terrain model, representing a variable Z as a function of horisontal coordinates X and Y in a fixed to ground coordinate system.

FIG. 6: Area with borders drawn for a material volume 181 subject to be loaded from by the system and including an obstacle-free zone 191 and zones for reconnaissance 192 and loading 193, respectively, an in preplanned reconnaissance path 111, a dynamically planned approach path 121 from a first switch point 1112 reconnaissance/approach path to a dynamically planned vehicle loading point 1221, the location for a dynamically planned switch point from approach to dynamically planned loading path 122 with its constituent dynamically planned movements of the load handling implement including the bucket, a dynamically planned transport path 124 governing the vehicle's 1 exit movement from the material volume and back to the waiting position 110 for change of direction backwards/forwards and static transport paths 112 to and from a vehicle unloading point 1231 with the constituent bucket movements required at unloading and exit from the unloading operation.

FIG. 7: Area with borders drawn for a material volume 181 subject to receive material in an unloading operation from the system and including an obstacle-free zone 191 and zones for reconnaissance 192 and unloading 194, respectively, a preplanned reconnaissance path 111, a dynamically planned approach path 121 from a first switch point 1112 reconnaissance/approach path to a dynamically planned unloading point 1231, and the related position 1232 of the bucket at unloading with its constituent dynamically planned movements of the load handling implement including the bucket, a dynamically planned transport path 124 governing the vehicle's 1 exit movement from the material volume and back to the waiting position 110 for change of direction backwards/forwards. Static transport paths 112 for transports in an out of the area are also indicated.

FIG. 8: Block diagram with essential to the invention environment sensors and computers required on board the vehicle, including

forward-looking scanning laser rangefinder 81 detecting and measuring, in a fixed to vehicle coordinate system, points on the surface of terrain, material volumes and on existing obstacles,

position determination system 7 yielding, in a fixed to ground coordinate system, the position of the vehicle in six degrees of freedom: coordinates x, y and z and attitude angles ψ (heading), Θ (pitch) and φ (roll),

the DTM-computer 82 for updating, maintaining and analysing the dynamic terrain model DTM where this computer, based on the measurements from the scanning laser rangefinder 81 and the six degrees of freedom position updates from the position determination system 7 computes coordinates in the fixed to ground coordinate system for points on the surface of terrain, material volumes and on existing obstacles, employs these coordinates for updating and maintaining the dynamic terrain model DTM and by analysing this model computes and delivers to the mission computer 6 coordinates far loading and unloading points and a loading height profile data for planning loading paths and implement movement parameters by loading from respectively unloading to a material volume or unloading pocket and where this DTM-computer also evaluates criteria for emergency actions e.g. at incident obstacles, rejected path plans etc. and in such cases sends the corresponding obstacle detection message 984 messages to the vehicle control computer 211,

the mission computer 6 in control of the mission program, for dynamic planning of vehicle paths and the detailed movement of the vehicle along these paths as for planning the movements of the bucket in loading/unloading operations, and during transit movements and sends mission specific and dynamic command data to the DTM-computer 82. The mission computer also furnishes the DTM-computer and the vehicle control computer 211 with vehicle control data lists 971 for steering and controlling the vehicle and its load handling implement,

the vehicle control computer 211, based on the vehicle control data lists 971 from the mission computer 6 or directly on any obstacle detection message 984 as obtained from the DTM-computer 82, steering and controlling the vehicle and the load handling implement in autonomous mode by means of a number of actuators and sensors installed in the vehicle's control system. In remote mode the vehicle is controlled directly by an operator via radio link and the vehicle control computer,

radio link 5 with radio link terminal 51 at operator station 3 and on board vehicle radio link terminal 52, for sending mission instructions to the mission computer 6 and for incidental commands and remote control signals to the vehicle and, in addition for returning status information and position data from the vehicle to

operator station 3 with MMI (man/machine interface) computer 31,

operator commanding and being provided with means for planning autonomous missions and, in exceptional or emergency case, for manual vehicle steering e.g. remotely via radio link.

FIG. 9: Dynamic approach path 121 with an inital set of a pair of clotoids and a circular path segment in between, followed by a straight path segment and finally again a pair of clotoids and a circular path segment in between.

FIG. 10: Flow and exchange of mission instructions and lower level messages and analysis and optimization tasks during reconnaissance and loading parts of a mission. Sample scenario.

FIG. 11: Load handling implement 14 with bucket 142 and elements of the vehicle's 1 mechanical framework. Skeleton model.

FIG. 12: Simplified model, built from rigid elements and pivot points, representing the mechanical structure of load handling implement 14 with bucket 142

FIG. 13: Dynamic loading path 122, shown as its projection on a fixed to ground coordinate system 41 x/y-plane, attack point 1222 for first entry of bucket in a material volume at loading, penetration depth s(i) for each index i=0,1,2,3, . . . , and estimated averages Z_{load}(i) for the height in fixed to ground coordinate system 41 for points on the surface of the material volume 181 along a linear element having a length equal to the width of the bucket and being oriented perpendicular to the direction of the loading path.

FIG. 14: Cut-out volume, visualised in a fixed to ground coordinate system 41 with a polygon section model of the bucket 142 in a sequence of positions at states k=0, 1, 2, 3, . . . of a conceptual loading process penetrating a material volume 181.

FIG. 15: Bucket's volume holding capacity visualised for two different bucket positions

FIG. 16: Terrain profile from current real terrain 17 with ground surface 171, material volume 181, and obstacle 182. Layer 1 drawing showing terrain profile from developing model from the vehicle's current running, layer 2 drawing showing profile of reference ground surface, current best estimate, layer 3 drawing showing profile of current best estimate of total terrain, difference Z(1,n)−Z(2,n), drawing showing profile of height above reference surface as calculated from developing and reference estimates.

FIG. 17: Fixed to ground projection of vehicle 1 and its obstacle avoidance mapping 1955 in the dynamic terrain model.

### DETAILED DESCRIPTION OF THE INVENTION

General

In the sequel the short notation of system is used for device, equipment, method or procedure or a combination of device or equipment and method or procedure.

With reference to the conceptual tree in FIG. 1 and its explanation below the invention concerns intelligent functions for controlling autonomous vehicles, machines and their implements based on laser-optic sensors for position determination and mapping of terrain, material volumes, and obstacles.

The expression remote control is used for a system where a vehicle more or less continuously is controlled by an operator via a communication medium, normally such as a radio link while physically seeing the vehicle and its working site or possibly by using a video link from a camera on board the vehicle but where such operator is working outside the vehicle.

The word autonomous is used in its regular meaning as independent and something capable of operation without outside control. It refers to an executing activity being either fully automatic or at least mainly automatic, that is with a human operator only being needed in exceptional and emergency situations. An autonomous vehicle must be capable of operating unmanned, that is without needing any human driver or other operator, be it on board or at some remote operator station, for controlling the vehicle and for maneuvering its implements. If human passengers are carried on board, where these passengers are not involved in steering or otherwise controlling the vehicle except for intervening in exceptional cases or in emergency situations, such a vehicle can still be called autonomous.

The expression preplanned control is employed for autonomous operation following an á priori produced plan but with quite limited or no provisions for reactions and making corrections in real time in order to meet changes and unexpected situations.

The word intelligent is employed for a system for autonomous operation which differs from preplanned controlled autonomous operation in that it is provided with means and elements for modeling and estimating variable states of nature, as well as means that based on these models and parameter estimates generates, simulates and evaluates alternative operation execution plans, modifies preliminary plans or creates new plans for the operations according to some optimality criteria for assuring that the chosen plan, with available means and resources and within given constraints such as costs of operation and available time, is expected to yield more and better production than other candidate plans. As with preplanned control, an intelligent system also has elements for pursuing the current planning by proper employment and control of available resources for the purpose of the system.

Description of the Invention

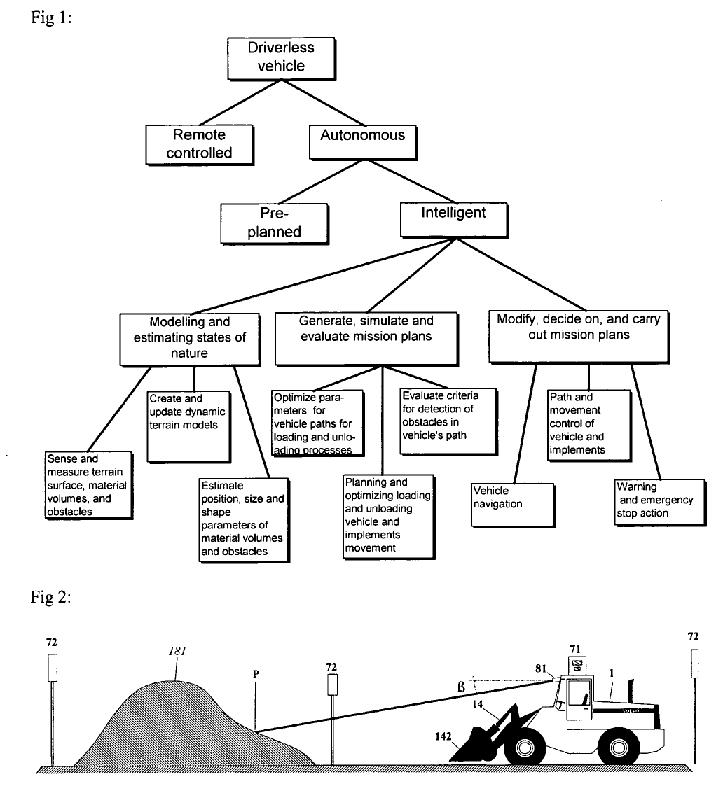

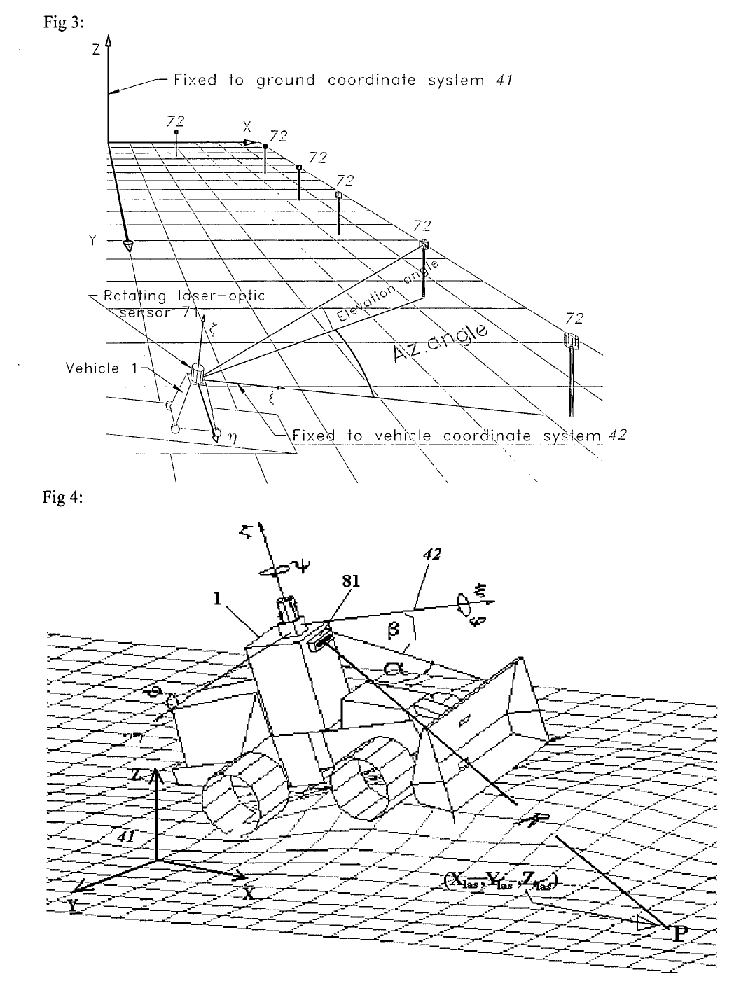

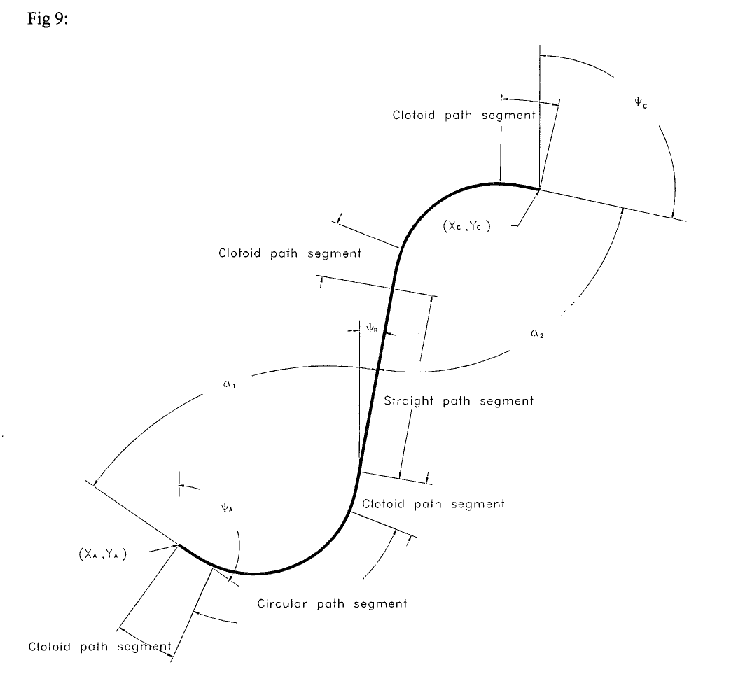

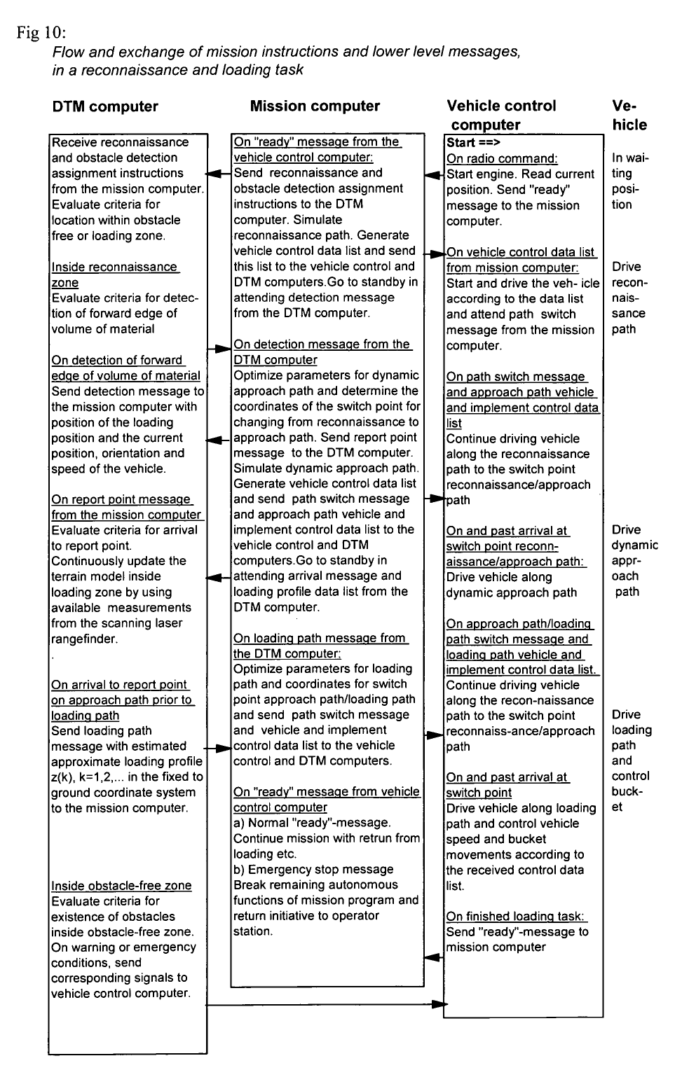

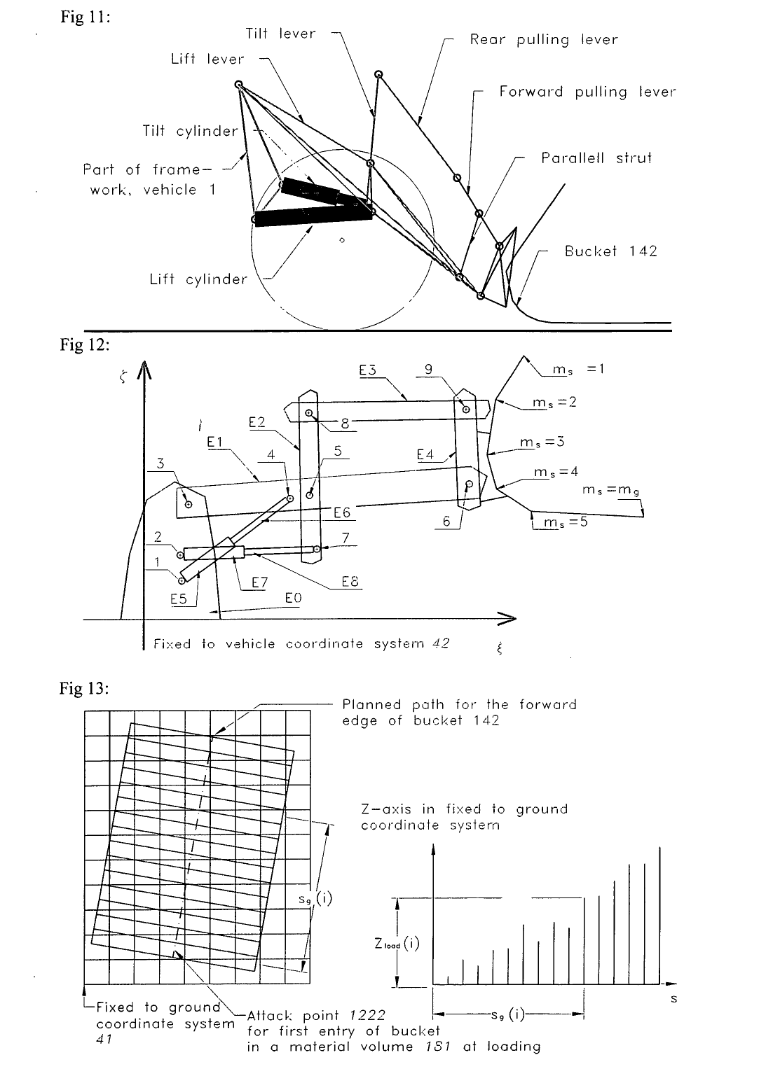

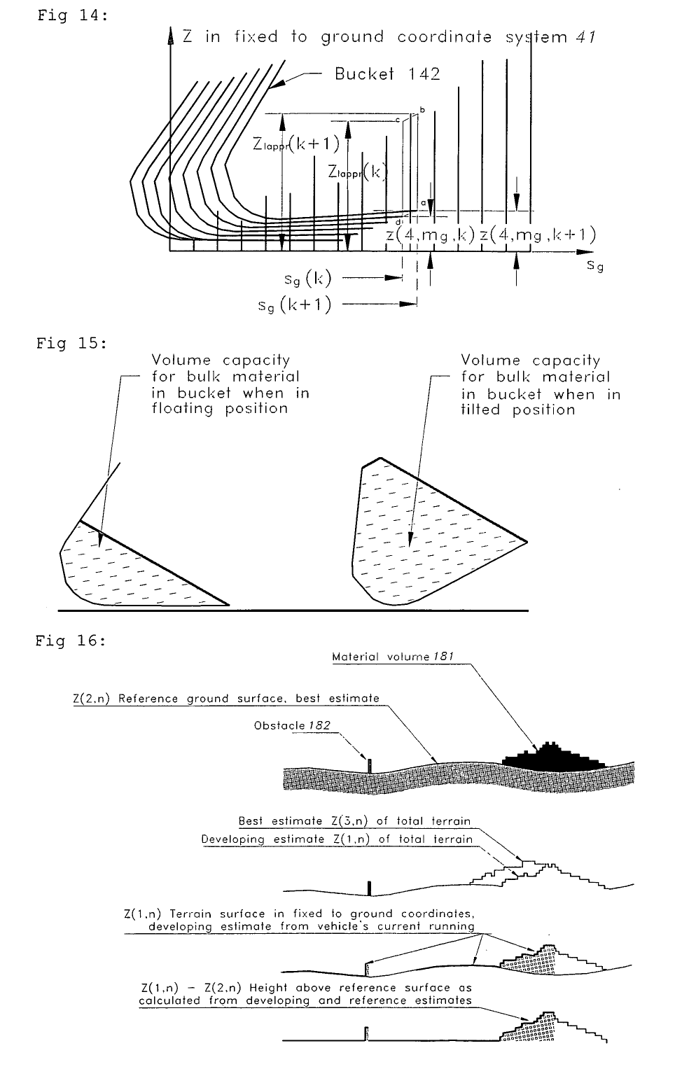

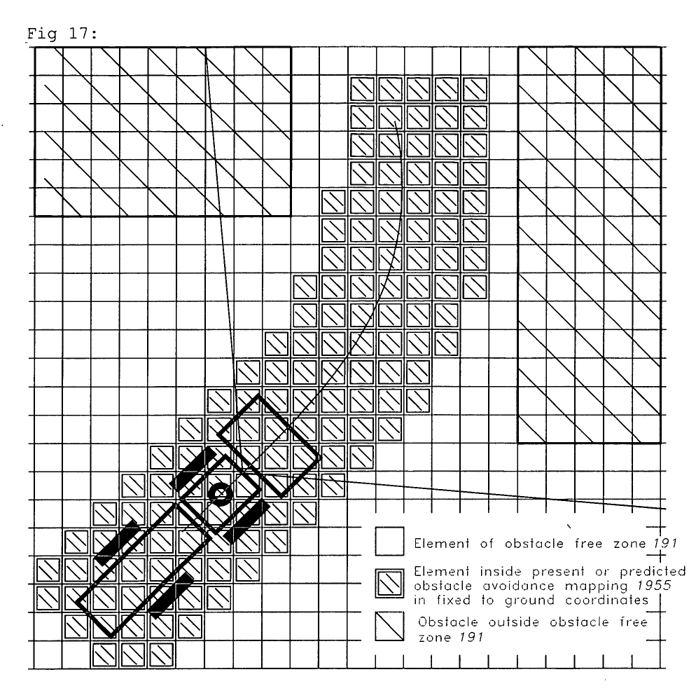

With reference to FIGS. 2, 3, 4, 5, 6, 7, 8, 16 and 17 the invention concerns procedures in the form of intelligent functions for autonomous vehicles and machines employed in loading, unloading and transportation, based on mapping of terrain comprising reference surface, material volumes and obstacles and on such information based functions for autonomous vehicle path generation and vehicle and implement movement planning and control and for obstacle detection with autonomous emergency action. The invention comprises thereby;

procedures for mapping a work site and its terrain surface comprising general handling objects 180, material volumes 181 and obstacles 182 by means of;

on board vehicle 1 sensors where such a vehicle is provided with a position determination system 7 with an on board vehicle rotating laser-optic sensor 71 for accurate position determination of the vehicle in three dimensions X, Y and Z in a fixed to ground coordinate system 41 and in addition heading, pitch and roll angle, by utilising fixed to ground reflectors 72 and;

a system 8 for measuring, modeling and analysing terrain, material volumes and obstacles where this system comprises a scanning laser rangefinder 81 and a dynamic terrain model 821, DTM, in a terrain model- or DTM-computer 82 for the purpose and provided with algorithms for measuring, and recording terrain surface, material volumes and obstacles and, based on this during a mission more or less continuously collected information and prior mappings of the area, at autonomous loading and unloading of material inside for the purpose enclosed areas optimize coordinates for nearest or otherwise most optimum attack point 1222 for loading where the center of the forward edge of the loading bucket 142 can begin its penetration of the material volume, and to estimate, for the purpose of controlling the load handling implement 14, a height profile for the material volume along the intended path of the bucket during the loading path and movement of vehicle and bucket, and correspondingly at unloading to optimize coordinates for most distant or otherwise most optimum emptying point 1232 for the bucket and;

by detection and in dangerous vicinity of any obstacle to prompt warning or emergency stop action, where the DTM-computer's reconnaissance and obstacle detection assignments are given from a;

mission computer 6, which for the execution of a specific mission has been provided, by radio link data sent from an operator station 3 with mission instructions 9 comprising mission program 91 for the superficial vehicle control in a mission and parameters 92 for static path 11 elements and prototype parameters 930 for the mission's dynamic path 12 elements and reconnaissance assignment 94 with defined zones and reconnaissance directions, loading, unloading and obstacle detection assignment 95 with border polygon list 951 for obstacle free zones 191 and border polygon list 952 with obstacle detection geometries and action parameters 195 for the vehicle and where this mission computer receives messages from the DTM-computer concerning coordinates and local terrain model for loading and unloading points, respectively, and by means of programs 611-613 for optimizing vehicle's path and vehicle's and load handling implement's movement, and program 614 for simulating and listing control data list 971 for controlling the path and movements of vehicle and load handling implement and sends this data list to;

a vehicle control computer 211 for the current path where this vehicle control computer via interface 212 to the electric and hydraulic systems of the vehicle controls the vehicle and its implement in thus dynamically planned paths and movements and on obstacles found by the DTM-computer and on direct obstacle detection messages 984 from this computer depending on the vicinity to the obstacle reduces vehicle speed or, like in case of interrupted radio communication 5 with the operator station, halts the vehicle and alarms for operator intervention.

With procedures in the form of intelligent functions for autonomous vehicles and machines based on laser-optic sensors for position determination and mapping of terrain, general handling objects, material volumes and obstacles and vehicle and implement control, the vehicle 1 is provided with a load handling implement 14 which includes a bucket 142 or other controllable implement for handling and carrying loads. For planning, monitoring and intervening the vehicle's operations there is an operator station 3 with man/machine interface (MMI) computer, 31, being provided with radio link 5 for communication with the vehicle's mission computer 6. The MMI computer can be provided with a number of preplanned mission instructions 9 each comprising one for each mission specific mission program 91 for distributing tasks and assignments to various subsystems on board and for controlling, during mission execution, that these tasks and assignments are carried out according to plans and where this mission program returns the initiative to the operator station when the mission is completed or if it is by any other reason interrupted. In the mission instruction there are also parameters 92 for static paths 11, prototype parameters 930 for dynamic paths 12, reconnaissance assignment 94 with, reconnaissance zone, border polygon list and reconnaissance direction 941, loading zone, border polygon list and loading direction 942, and unloading zone, border polygon list and unloading direction 943 and obstacle detection assignment 95 with obstacle free zones 191, border polygon list 951 and vehicle's obstacle detection geometries 195 and action parameters 952. In order to initiate such a mission, mission instructions 9 are sent from operator station 3 to the vehicle's mission computer 6 via radio link 5.

In the total system there is a position determination system 7. This is employed for vehicle 1 navigation, and provide position and attitude angles in a fixed to ground coordinate system 41 for a fixed to vehicle coordinate system 42 to applications such as coordinate conversion of data from a fixed to vehicle scanning laser rangefinder 81 belonging to on board vehicle subsystem 8 for detecting and measuring terrain surface, any general handling object 180, material volume 181 and any obstacle 182. The position determination system delivers in a fixed to ground coordinate system 41, vehicle position in six degrees of freedom, being x-, y- and z-coordinates and the three attitude angles ψ (heading angle), Θ (pitch angle)and φ (roll angle). In the fixed to ground coordinate system the X-axis can be defined as one towards north oriented vector in the horisontal plane, the Y-axis as a vector also in the horisontal plane, perpendicular to the X-axis and oriented to east. The Z-axis is a perpendicular vector to the same horisontal plane and perpendicular both to the X-axis and the Y-axis and oriented upwards, towards zenith. The fixed to vehicle coordinate system 42 is also a right angular coordinate system, its ξ-axis can be defined to be oriented in a forward direction along the full length direction of the vehicle, the η-axis oriented in the vehicle's athwart direction and the ζ-axis upwards and perpendicularly to both the ξ-axis and the η-axis. The fixed to vehicle coordinate system's position and orientation in space is defined by the position (x,y,z) for its origo and its rotations in the fixed to ground coordinate system are defined by the three attitude angles ψ (heading angle), Θ (pitch angle)and φ (roll angle). The angle ψ can now be defined as a clockwise rotation of the fixed to vehicle coordinate system around its own ζ-axis, as seen from a point on the positive part of this ζ-axis. In the same way the angle Θ is defined as a counter clockwise rotation of the fixed to vehicle coordinate system around its own η-axis, as seen from a point on the positive part of this η-axis, and the angle φ as a counter clockwise rotation of the fixed to vehicle coordinate system around its own ξ-axis, as seen from a point on the positive part of this ξ-axis.

Such a position determination system 7 can be set up according to the procedures given in U.S. Pat. No. 5,242,481 and which, in order to obtain six degrees of freedom in position determination performs angular measurements in azimuth and elevation to a number of fixed to ground reflectors 72.

The present invention is a further development from this U.S. patent through employment of a forward looking scanning laser rangefinder 81, for the purpose of with high precision detecting and measuring the terrain, material volumes and other objects such as obstacles in front of the vehicle, and its associated DTM-computer 82 for the purpose of converting, based on the six degrees of freedom data from the position determination system 7, the measurements from the scanning laser rangefinder into coordinates in the fixed to ground coordinate system 41 for points on the terrain surface, on material volumes 181 and on occurring obstacles 182, and by these means build up and a dynamic terrain model DTM 821. Based on such a DTM various analyses can be performed enabling dynamic planning of the vehicle's 1 movements such as the optimization of coordinates for target points and path layouts for the vehicle's movement in loading and unloading tasks, and for optimization of parameters for movements of the vehicle's and its implements in such loading and unloading operations. In addition, the DTM can be used for detecting, inside obstacle free zones 191, any occurring obstacles and to prompt suitable reactions.

Furthermore the vehicle 1 is arranged for autonomous operation by being provided with a vehicle control computer 211 with interfaces 212 to the vehicle's electrical system, including engine, gearbox, main brake, parking brake, and vehicle steering system, and interfaces to the load handling implement's 14 sensors and actuators, interface to a position determination system 7, interface to the operator station 3 via radio link 5, interface to the mission computer 6 and, for obstacle avoidance functions also an interface to the DTM-computer 82 with its digital terrain model 821.

The main action of the vehicle control computer 211 is based on the vehicle and implement control data list 971 which is dynamically generated by the mission computer 6 by means of a program 614 for simulating and producing a time sequential listing of control variables such as coordinates for the path of the vehicle, heading angle and speed for the movement of the vehicle and actuator positions, engine rpm and hydraulic pressure levels for the movement of the load handling implement 14. Such a list is produced for each path from one point to another on the path where such a point either is a point where the vehicle is standing still for a moment or a specified switch point where the vehicle's control is intentionally switched from one vehicle and implement control data list to another without neccessarily requiring the vehicle to stand still. For a static path 11 the vehicle and implement control data list is generated in the mission computer from a set of prepared parameters 92 for static path, while for a dynamic path 12 the vehicle and implement control data list is generated from a set of parameters 931 dynamically optimized by a program in the mission computer 6. For this purpose, programs for optimization of approach, loading paths and unloading movements 611, 612, and 613, respectively, are used along with both a set of prototype parameters 930, and a set of measurements and data from the DTM-computer 82 in the form of detection, loading path and unloading point messages 981, 982, and 983, respectively.

In the DTM-computer 82 there is a dynamic terrain model DTM 821 which covers the entire work site with transport routes and zones for reconnaissance 192, loading 193 and unloading 194. The DTM computer receives, continuously during the mission, position data from the position determination system 7. By means of from the position determination system obtained coordinates and attitude angles, in the fixed to ground coordinate system 41 for a six degrees of freedom position of the fixed to vehicle coordinate system 42, the laser rangefinder 81 measurements are transformed from this fixed to vehicle coordinate system, to positions in the fixed to ground coordinate system for updates of the DTM. Via the mission computer 6 the DTM computer is provided with suitable zone border polygon lists 941, 942 and 943 for reconnaissance 192, loading 193, and unloading zones 194, respectively, as provided in mission instruction 9. Based on these data a criterion is evaluated in the DTM computer to decide when the vehicle is inside reconnaissance zone whence this computer commences to actively update, by using range and angle measurements from the scanning laser rangefinder 81, the DTM 821 inside the current loading or unloading zone.

During a loading or unloading operation a reconnaissance path 111 is inserted after some initial static paths possibly required in order to get the vehicle sufficiently near the current loading or unloading zone. During the reconnaissance path the objective is to detect a feasible point, the attack point 1222 on the material volume 181 where the bucket 142 can start to penetrate during a dynamic loading path 122 with its constituent movements of vehicle and bucket or a feasible location, the bucket emptying point 1232 with its constituent movements of vehicle and bucket.

In parallell with the above DTM 821 updating process the DTM computer 82 also analyses a developing part of the DTM as updated by the incoming measurements when advancing in the reconnaissance path in order to find, in a loading operation, by means of a specific algorithm 824 for optimizing the attack point 1222 position, the nearest or otherwise most optimal attack point, or, in an unloading operation, by means of a specific algorithm 826 for optimizing the bucket emptying point 1232 position, the most distant or otherwise most optimal point. As soon as the optimal coordinates of such a point 1222 or 1232 has been found the DTM computer sends, to the mission computer 6, a detection message 981 with coordinates for the vehicle's 1 current position and coordinates for the optimal attack or unloading point. In the mission computer can then be obtained parameters for a dynamic approach path 121, by means of mission computer program 611 for approach path optimization, based on the arriving data from the DTM computer and also on prototype path parameters 930 in mission instruction 9. This dynamic approach path, as defined by parameters 9311, vehicle and implement control data list 971, and switch point reconnaissance/approach path 1112 for finishing the current reconnaissance path 111, leads the vehicle to a suitable position, vehicle loading point 1221 representing the position of the vehicle in front of the attack point 1222 in a loading operation, or unloading point 1231 representing the position of the vehicle in front of the bucket emptying point 1232 in an unloading operation. The mission computer also sends a path switch message 972 with coordinates for the switch point and approach path vehicle and implement control data list to the vehicle control computer 211. The mission computer also sends a report point 1211 message 973 to the DTM computer with coordinates for the point on the path where the DTM computer shall deliver, to the mission computer in a loading operation, a loading path message 982 with estimated coefficients 9821 for an analytic approximation of the ground surface at the vehicle loading point and a loading height profile data list 9822 with z-coordinates for points on the material volume 181 surface along the loading direction from the attack point 1222, or in an unloading operation a vehicle unloading point message 983 with estimated coefficients 9831 for an analytic approximation of the ground surface at the unloading point and a vehicle unloading point local terrain model parameter list 9832 for a local terrain model of the material volume around the bucket emptying point 1232. The DTM-computer analyses the developing DTM in order to perfect the coefficients and parameters required by the mission computer. When, in a loading operation, the report point has been reached and the loading path message 982 has been sent over from the DTM computer the mission computer then optimizes the loading path 122 parameters 9312 based on the received message data, and loading path prototype parameters 9302 in the mission instructions 9. This optimization is done by means of program 612 for loading path and its constituent bucket movement optimization. In an unloading operation, when the unloading point message 983 has been sent over from the DTM computer, the mission computer then optimizes the unloading movement parameters 9313 based on the received message data, and unloading operation prototype parameters 9303 in the mission instructions 9. This is done by means of program 613 for unloading bucket movement optimization.

When in this way the valid parameters for loading or unloading vehicle path and vehicle and implement movements are available, before actually being carried out, these movements are simulated in the mission computer by means of its vehicle path and load handling implement movement simulation algorithm 614. By this simulation, a new vehicle and implement control data list is generated which then is sent to the vehicle control computer. This computer switches its control of the vehicle and its implements from the approach path to the loading path or unloading movement according to the received data upon arrival to the vehicle loading point 1221. Finally, the vehicle's advancing movements are retarded and brought to finish, while the bucket 142 is allowed to perform its proper movements as planned for the loading or unloading operation in question. When even these movements are finished, the vehicle control computer requests, for the return path 124 and its constituent bucket movements, a new vehicle and implement control data list from the mission computer. The mission computer then optimizes the return movement parameters for a path to some point where the mission can be further continued according to the mission program 61, based on the actual position of vehicle and implements in the finished loading or unloading movements, and if from a loading operation also based on prototype parameters 9304 for a dynamic return transport path 124.

During all operations with an autonomous vehicle or machine 1 according to this invention, another duty for the DTM computer 82 is to compare currently received measurements from the scanning laser rangefinder 81 with the already available dynamic terrain model when in the obstacle free zone 191, and also to continuously evaluate criteria for obstacle detection or any possible intrusion of the vehicle or machine outside the obstacle free or loading or unloading areas.

Measuring Terrain Comprising Reference Surface, General Handling Objects, Material Volumes and Obstacles

The scanning laser rangefinder 81 ought to be installed relatively high on the vehicle 1, cf FIG. 2, such as on the forward edge of the vehicle's cabin roof, forward oriented and in addition inclined downwards. The laser light is pulsed and its time of flight to reflection and back to the receiver is employed for the distance measurement. The laser rangefinder is scanning in azimuth by means of a rotating mirror. This way, the laser rays are sent out in a plane parallell to the η-axis of the fixed to vehicle coordinate system 42 but with a perpendicular to the plane tilted forwards in the ξ- ζ-plane with an angle β from the ζ-axis. The laser rays will hit the terrain in a sequence of points and as seen in a cross section in the point P (FIG. 2). The scanning laser rangefinder 81 measures distance R to a reflection and angle α, cf FIG. 4, in the inclined plane where this angle is defined of a) the abovementioned vehicle ξ-axis and b) by the instantaneous vector orientation of the laser ray.

The coordinate vector χ=(ξ, η, ζ) for the position in the fixed to vehicle coordinate system 42 for each such point P can now be obtained by means of these measurements α and R, the scanning laser rangefinder's 81 position (ξₒ, ηₒ, ζₒ) in the fixed to vehicle coordinate system and the scanning laser rangefinder tilt angle β from the ξ-axis:

$$\begin{matrix}ξ = {ξ}_{0} + R cos αcosβ \\ η = {η}_{0} + R sin α \\ ζ = {ζ}_{0} + R cos α sin β\end{matrix} \} \qquad ( 1 )$$

With these coordinates in the fixed to vehicle coordinate system 42 and by employing the six degrees of freedom position data from the on board position determination system 7 the coordinates of the scanning laser rangefinder's measured point P can now be obtained in the fixed to ground coordinate system 41. The six degrees of freedom position determination from system 7 comprises the X=(X, Y, Z) and the attitude angles ψ, Θ and φ, the latter needed for the transformation matrix M(ψ, Θ, φ):

$$M ( ψ , ϑ , ϕ ) = [ \begin{matrix}cos ψ cos ϑ , & sin ψcos ϑ , & sin ϑ \\ - sin ψ cos ϕ + cos ψ sin ϑ sin ϕ , & cos ψ cos ϕ + sin ψsin ϑ sin ϕ , & - cos ϑsin ϕ \\ - sin ψ sin ϕ - cos ψsin ϑ cos ϕ , & cos ψsinϕ - sin ψsin ϑ cos ϕ , & cos ϑcos ϕ\end{matrix} ] \qquad ( 2 )$$

The Xₗₐₛ=(xₗₐₛ, yₗₐₛ, zₗₐₛ) in the fixed to ground coordinate system 41 for the point P can now be obtained as:

Xₗₐₛ=X+χM(ψ, Θ, φ) (3)

This way, each measurement with the scanning laser rangefinder 81 results in a three dimension coordinate determination in the fixed to ground coordinate system 41. The calculations of equations (1), (2) and (3) are made in the DTM-computer 82, and the obtained coordinates are first compared with the current dynamic terrain model 821 in the DTM-computer, such as for detecting a new obstacle, and finally for updating the dynamic terrain model.

Such a terrain model 821 can be based on a square grid. With a square mesh side length of d=0.33 m an area of 100,000 m² is covered by roughly one million squares. If for each square is stored 32 byte index, Z-value, age of data and accuracy measure in the dynamic terrain model 821 a storage space of 32 Mbytes is required in the DTM-computer 82 for this model allowing a resolution of some 1/64000 in the Z variable. Let a square be identified as (i,j) when its four corners has the coordinates in plane X/Y:

lower left corner: (i−1,j−1)d (4a)

lower right corner: (i−1,j)d (4b)

upper left corner: (i,j−1)d (4c)

upper right corner: (i,j )d (4d)

The centre point of a square identified as (i,j) has the coordinates in plane X/Y:

$$\{ \begin{matrix}{X}_{i} = ( i - 0.5 ) d , 1 \leq i \leq i max & & & & & & & & ( 5 a ) \\ {Y}_{j} = ( j - 0.5 ) d , 1 \leq j \leq j max & & & & & & & & ( 5 b )\end{matrix}$$

Each measurement Xₗₐₛ can then be computed with or update the terrain model 821 in the square (i,j) where these indexes i and j are determined by the inequalities:

$$\{ \begin{matrix}( i - 1 ) d < {x}_{las} \leq i d & & & & & & & & ( 6 a ) \\ ( j - 1 ) d < {y}_{las} \leq j d & & & & & & & & ( 6 b )\end{matrix}$$

The dynamic terrain model DTM 821 is required to be defined in every point of an entire work site be it for comparisons with fresh measurements (obstacle detection), or be it for optimization of coordinates 9811 and 9812 for attack point 1222 or bucket emptying point 1232 and for optimizing loading path 122 and unloading movement 123 where such optimizations require estimations of loaded volume or available volume for unloading material for various sets of parameters for these movements. Some parts of the DTM can be prepared before a mission is executed while others are based or updated also in important layers from earlier measurement runs with vehicle and its sensors. To each square (i, j) in the DTM, 1≦i≦imax and 1≦j≦jmax an ordered sequence of numbers n can be defined in a way so that to each integer value n corresponds unambiguously a certain model square (i,j) and to each model square (i,j) corresponds the same number n:

$$n = \{ \begin{matrix}i \cdot i max + j if j max \leq i max \\ i + j \cdot j max if i max < j max\end{matrix} \} \qquad ( 7 a )$$

or the inverse:

$$\begin{matrix}i = \{ \begin{matrix}integer part of fraction n / i max & if & j max \leq i max \\ n \text{-} j \cdot j max & if & i max < j max\end{matrix} \} & ( 7 b ) \\ j = \{ \begin{matrix}n \text{-} i \cdot i max & if & j max \leq i max \\ integer part of fraction n / j max & if & i max < j max\end{matrix} \} & ( 7 c )\end{matrix}$$

Various layers can be employed in the DTM for separating different kinds of zones and data in the DTM. Cf FIG. 16. The identification Z(LAG, n) represents Z-coordinate i layer LAG for element n in DTM. In the sequel is employed:

Layer 0. Index number n

Layer 1. Z(1, n) is a developing estimate based on measurements only from the vehicle's current running in the path for detecting and measuring the terrain surface including handling objects 180, material volumes 181, and obstacles 182.

Layer 2. Z(2, n) represents the reference ground surface and is intended to be an actual best model estimation of the real ground surface without any handling objects, material volumes, or known and unknown obstacles.

Layer 3. Z(3, n) is intended to be a current best model estimation of the total site terrain surface and represents handling objects, material volumes and known obstacles for which the Z-values of the model elements are determined from measurements from earlier paths and operations on the site or otherwise provided fundamental data. It is also assumed that measurements from earlier unknown but after the detection physically removed obstacles have been cleaned away from those model squares once occupied by measurements from such currently removed obstacles.

Layer 4. Obstacle-free zone 191 denotation field. Z(4, n)=1 for obstacle free zone.

Layer 5. Reconnaissance zone 192 denotation field. Z(5, n)=1 for reconnaissance zone.

Layer 6. Loading zone 193 denotation field. Z(6, n)=1 for loading zone.

Layer 7. Unloading zone 194 denotation field. Z(7, n)=1 for unloading zone.

Measurements concerning element n can be stored in several ways:

Last measured Z-value, written as Z₋₁ (L, n), is stored. Once stored, the value is written as Z₀(L, n)

A moving average from the last k measurements is stored and written also as Z₀(L, n), that is

Z₀(L, n)=[Z₋₁(L, n)+Z₋₂ (L, n)+ . . . +Z₋ₖ(L, n)]/k (8a)

A recursive filter with the experimental filter coefficient γ, 0<γ<1 is employed for updating the model value Z₀ (L, n) with the value Z₋₁(L, n) from the last measurement. The filter can be initialised by: Z₀(L, n)=Z₋₁(L, n) the first time a measurement represents element n, sub-sequently the following recursive filter equation can be employed:

Z₀(L, n)=γZ₀(L, n)+(1−γ)Z₋₁(L, n) (8b)

This kind of method is suitable if a large number of measurements is expected for each element number n.

Criteria for DTM-Based Obstacle Detection

Autonomous driving is allowed in obstacle free zones 191 and in loading 193 and unloading zones 194. Obstacle free zones are only allowed outside loading and unloading zones. The objective of the DTM-based-obstacle detection function is to test for obstacle detection in element n the hypotesis that the criterion H≦[Z(1,n)−Z(3,n)] holds for a minimum obstacle height H for each element n where Z(4,n)=1 and where this element is located inside or within a specific neighbourhood of the vehicle in its current or planned and predicted position. Thus, if an obstacle is detected in element n of the DTM, Z(4,n) is set to zero until the obstacle is removed. Employing the differences Z(1,n)−Z(3,n) has the benefit, especially in cases of uneven terrain and reference surface, to produce more accurate measurements of obstacles. Cf FIG. 16.

Creation and Updating of Material Volume Models

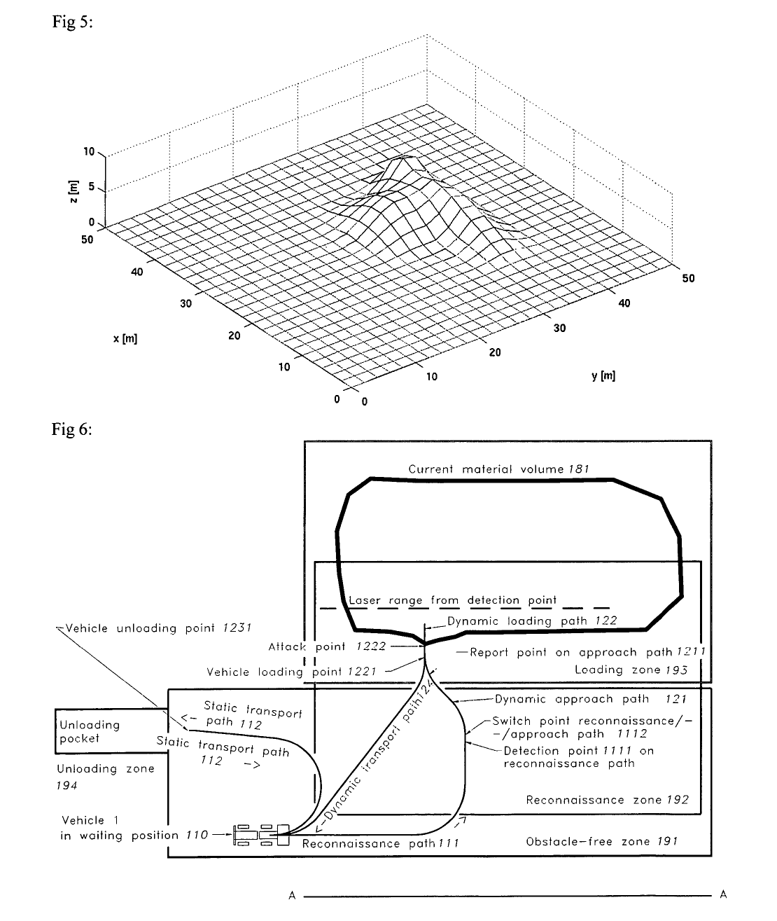

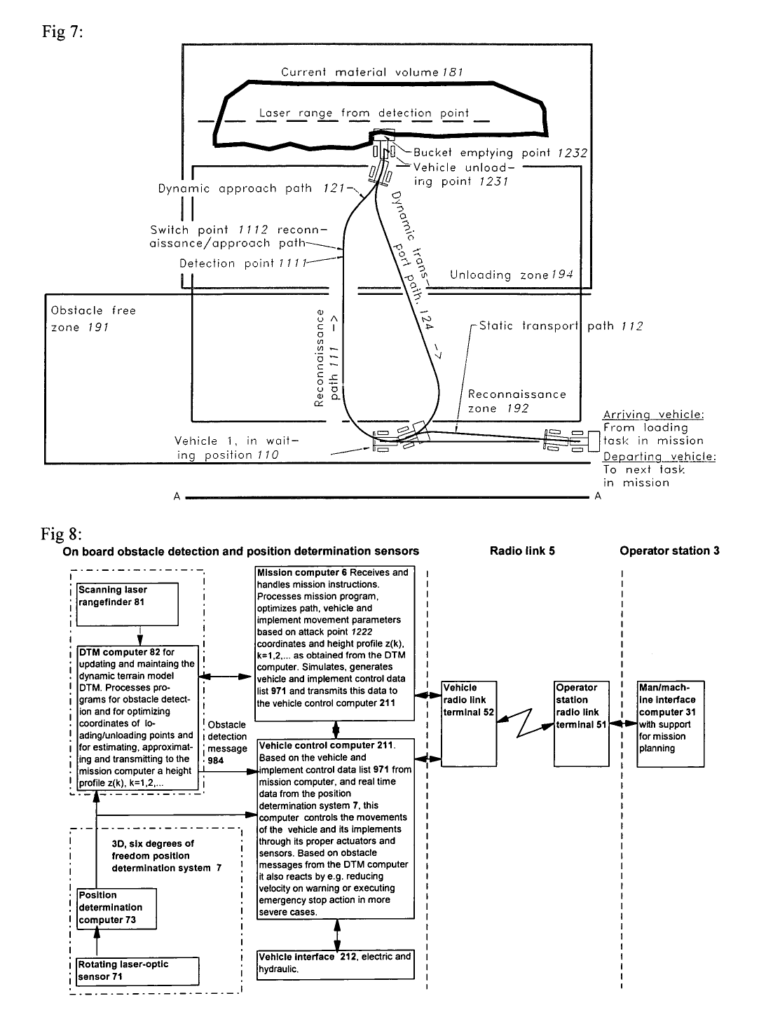

As the vehicle on reconnaissance path 111 enters reconnaissance zone 192, cf FIGS. 6 and 7, those measurements representing terrain model elements inside loading 193 or unloading 194 zone are used to create and update the developing layer 1 of the DTM model inside such a zone representing the material volume model. The purpose is primarily to collect fresh data for the currently forthcoming approach path 121, loading path 122, or unloading movement 123. By storing model values to the next path or operation such a dynamic model can contain certain errors as the shape and size of the material volume 181 might have changed when it is going to be approached next time. On the other hand it would be of value if neighbouring loading or unloading zone elements not centrally involved in the previous run still have become updated in the model during such a run to be used for e.g. planning further reconnaissance paths in this area.

Optimization of Attack Point 1222 and Bucket Emptying Point 1232 Coordinates

Several factors have to be considered when optimizing attack point 1222 position in a loading operation. It is important to select such attack points so that the remaining material does not risk to interfere with the return movements from a loading path 122. For this reason strategies leaving an outward concave material volume front ought to be avoided even if such a strategy at first thought might appear attractive in order to minimize distance travelled. On the other hand a strategy producing an outward convex front would lead to unneccessarily long travel distances and require quite large areas for vehicle maneouvers. Therefore, a strategy leaving a straight front line is the natural choice. These factors are also applicable in unloading. This way, the material volume 181 can be attacked from one direction all the time thus considerably simplifying approach and exit path planning.

A method to get such a straight front line is, to select attack point 1222 or bucket emptying point 1232 on edges of the material volume 181 maximally deviating from such a straight front line. A straight line facing and parallell to the desired front line and located at some distance from the front can serve as reference. In a loading operation, attack points are chosen where the distance between the candidate point and this reference line is minimum. In an unloading operation, bucket emptying points are chosen where this distance is maximum. For the DTM 821 has been defined Z(6,n)=1 to represent a situation where element n is in a loading zone 193 and Z(7,n)=1 means that element n is in an unloading zone 194.

Threshold levels H_{load} and H_{unload} representing least volume height worth loading from and maximum volume height worth filling to, respectively, are employed in order to avoid that too small spill heaps, material rests and unevenness would cause unnecessary work load.

Optimizing the Coordinates of Attack Point and Bucket Emptying Point

a) Based on Nearest or Most Distant Point in the Material Volume as Measured from a Reference Line

When the vehicle 1 in a loading operation, cf FIG. 6, drives forward on reconnaissance path 111 and begins approaching a material volume 181 in a loading zone 193 measurements will commence regarding elements of DTM 821 inside the loading zone with a height above threshold level for loading, provided there is material enough to load. In order to avoid, in situations with a multitude of elements in the DTM suitable for loading, that only the first element that satisfies the threshold criterion will be selected, it is required that the vehicle continues a given further distance after this event. The endpoint on this travelling distance can be defined as detection point 1111. At this detection point it is possible that a multitude of elements have been recorded and can be employed for final selection of attack point 1222 for loading. If still only the first detected element has been recorded it is probably singular in a sufficiently large environment and can therefore be selected as attack point on good grounds in such a case. The detection event is defined as the moment when the vehicle arrives at this detection point.

For an unloading operation, cf FIG. 7, a similar reasoning leads to a procedure for selecting bucket emptying point 1232. A criterion for this point in unloading is that the vehicle 1 has moved a given further distance since the first occurrence of measurements representing elements in the DTM 821 where the element volume is measured not to allow further unloading, alternatively that the entire surface is empty, thus allowing the reconnaissance path to be aborted when the most remote border of the unloading zone 194 has been passed, with required margins, by the measurements of the scanning laser rangefinder 81. The unloading can start at this most remote border.

At detection point 1111 the binary occupancy vectors Q_{load}(n) and Q_{unload}(n) can be defined as

$${Q}_{load} ( n ) = \{ \begin{matrix}0 & if [ Z ( 1 , n ) - Z ( 2 , n ) ] < {H}_{load} \\ 1 & if {H}_{load} \leq [ Z ( 1 , n ) - Z ( 2 , n ) ]\end{matrix} \} \\ and \qquad ( 9 a )$$

and

$${Q}_{unload} ( n ) = \{ \begin{matrix}0 & if {H}_{unload} \leq [ Z ( 1 , n ) - Z ( 2 , n ) ] \\ 1 & if [ Z ( 1 , n ) - Z ( 2 , n ) ] < {H}_{unload}\end{matrix} \} \qquad ( 9 b )$$

As attack point 1222 for loading and bucket emptying point 1232 at unloading can now be selected the coordinates for element n=n_{load} and n=n_{unload} when these points are most close and most distant, respectively, from a straight line, arbitrarily chosen to suit the purpose, cf “A-A” in FIGS. 6 and 7, and where the elements n_{load} and n_{unload}, respectively, also satisfy the conditions:

for loading, requirement for n_{load}

$$\{ \begin{matrix}{Q}_{load} ( {n}_{load} ) = 1 & & & & & & & & ( 10 a ) \\ Z ( 6 , {n}_{load} ) = 1 & & & & & & & & ( 10 b )\end{matrix}$$

for unloading, requirement for n_{unload}

$$\{ \begin{matrix}{Q}_{unload} ( {n}_{unload} ) = 1 & & & & & & & & ( 11 a ) \\ Z ( 7 , {n}_{unload} ) = 1 & & & & & & & & ( 11 b )\end{matrix}$$

b) Based on Nearest or Most Distant Point in a Cell Belonging to an Ordered Sequence:

In this alternative each element n satisfying Z(6,n)=1 or Z(7,n) =1 belongs to an ordered sequence N=1,2,3, . . . , NMAX of cells, where we take Γ(N,n)=1 to indicate that element n belongs to cell N. At loading and unloading, to the condition pairs (10a), (10b) and (11a), (11b), respectively, are added the further conditions:

Γ(N, n_{load})=1 (10c)

Γ(N, n_{unload})=1 (11c)

where cell N is currently selected for loading/unloading.

Path Generation at Entering and Exiting from a Loading or Unloading Zone

A mission instruction 9 with loading or unloading operations has to be prepared with at least one preplanned static reconnaissance path 111, for the vehicle 1 to follow while its sensors are scanning and analysing the material volume 181 from or to which loading or unloading, respectively, is desired, cf FIGS. 6 and 7. During the vehicle's travel along this reconnaissance path, coordinates for an attack point 1222 or for a bucket emptying point 1232 are obtained at the detection point 1111, as a result of the analysis in the DTM-computer 82 by means of the abovementioned conditions and criteria applied on the successively, during the vehicle's travel, developing Z(1, n), n=1, 2, 3, . . . of the dynamic terrain model 821. At the detection event as-defined above, the DTM-computer sends a detection message 981 to the mission computer 6 with coordinates 9811 or 9812 for the selected attack point or bucket emptying point, respectively. It is now possible for the mission computer to determine the position of a switch point 1112 where the reconnaissance path can be finished and an approach path 121 can start, by knowing the amount of time required for the system to optimize, parameters 9311 for the dynamic approach path 121 and produce and send vehicle and implement control data list 971 to the vehicle control computer 211. The approach path has to be designed to lead the vehicle to a position, the vehicle loading point 1221, the position of the vehicle 1 when the bucket 142 starts penetrating the material volume 181 at the attack point 1222 or, in an unloading operation to a position, the unloading point 1231, from which the vehicle can start some finishing maneouvers to be prepared for the unloading movement 123. The coordinates (X_{C}, Y_{C}, Z_{C}) for the vehicle's position in the vehicle loading point can be obtained from the coordinates of the attack point by knowing the geometry of the vehicle and its load handling implement 14 and the actual loading direction ψ_{C}. Coordinates for the vehicle's position in a vehicle unloading point can be obtained in an analogous way.

As the selected loading or unloading point not always is located straight in front of the vehicle 1, the dynamic approach path 121 has to allow for, on the travel from the switch point 1112, first a sideways translation of the vehicle, and second to guide the vehicle to the intended direction in the vehicle loading 1221 or vehicle unloading point 1231. Thus a more or less s-shaped path is required. By employing, in path generation, a mix of clotoid, circular and straight path segments, where the clotoid segments will bring the path's radius continuously between straight path and least turning radius, a large variation of such paths can be designed in a manner which is contributing to limit steering errors. A simple two-dimensional path model of limited complexity that works well for this purpose, cf FIG. 9, consists at its maximum of two bends with a straight path between. In the first bend the heading angle is changing the amount α₁, and α₂ in the second. Each bend consists of a pair of clotoids and, for large α₁ and α₂, a circular path segment inserted between bending and straightening clotoid. For a simple path without any obstacle, where start point and end point are given as three-dimensional coordinate vectors X_{A} and X_{C} and heading angles ψ_{A} and ψ_{C} respectively, a formulation of the problem can be reduced to three non-linear equations, one for X-coordinate, one for Y-coordinate, and one for heading angle ψ. A practical assumption is to optimize the path in the two dimensions X and Y only. The Z-coordinate of the path will then follow from the dynamic terrain model 821. The following variables and equations are used:

X_{A}=(X_{A}, Y_{A}, Z_{A}) and ψ_{A} are coordinates and heading angle in the fixed to ground coordinate system 41 for vehicle 1, in switch point 1112 reconnaissance/approach path

X_{C}=(X_{C}, Y_{C}, Z_{C}) and ψ_{C} are coordinates and heading angle in the fixed to ground coordinate system 41 for vehicle 1 in loading 1221 respectively unloading point 1231.

The three equations can be written

$$\begin{matrix}{X}_{C} - {X}_{A} = {\sum }_{k = 1}^{7} X ( k ) , vectorial equation in 3 D & ( 12 a ) \\ {ψ}_{C} - {ψ}_{A} = {\sum }_{k = 1}^{7} ψ ( k ) & ( 12 b )\end{matrix}$$

where the three dimensional vector X(k) and the angle ψ(k) constitute the additive contribution in coordinates X andY respectively heading angle ψ from each of the path segments No. k=1, 2, 3, . . . ,7.

Each one of the two bends of the assembled curve, consists of one bending and one straightening clotoid segment and has to include, if the total heading angle change αᵢ in bend number “i” amounts to more than a determined amount αₒ, one between the two clotoid segments inserted circular segment with bending angle α_{c}=αᵢ−αₒ

The vector klot(Mᵢ,sᵢ) is employed for the bending clotoid in bend No. i as a function of the parameter Sᵢ and the clockwise/counterclockwise factor Mᵢ

(clockwise, Mᵢ=1, counterclockwise, Mᵢ=−1)

$$klot ( {M}_{i} , {s}_{i} ) = [ {\int }_{u = 0}^{u = {s}_{i}} cos ( {u}^{2} / 2 ) ⅆ u , {M}_{i} {\int }_{u = 0}^{u = {s}_{i}} sin ( {u}^{2} / 2 ) ⅆ u ] \qquad ( 13 a )$$

and the vector cirk(Mᵢ,α_{c}) for the circular path as a function of its bending angle α_{c} and Mᵢ

cirk(Mᵢ,α_{c})=[sinα_{c}, Mᵢ(1−cosα_{c})] (13b)

where

$${s}_{i} = \{ \begin{matrix}\sqrt{{α}_{i}} & if & {α}_{i} < {α}_{o} \\ \sqrt{{α}_{o}} & if & {α}_{o} \leq {α}_{i}\end{matrix} \qquad ( 13 c )$$

The following 3D coordinate transformation matrix is employed.

$$M ( {ψ}_{i} ) = [ \begin{matrix}cos {ψ}_{i} & - sin {ψ}_{i} & 0 \\ sin {ψ}_{i} & cos {ψ}_{i} & 0 \\ 0 & 0 & 1\end{matrix} ] \qquad ( 14 )$$

The contributions of each of the seven partial segments to the terms in equations (12a) and (12b) can now be stated. For the partial segments 1-3 and 5-7 the characters M₁ respectively M₂ for their clockwise/counterclockwise factors and the characters α₁, S₁ and α₂, S₂ for angles and arguments for their clotoid vectors.

Partial segment 1. Bending clotoid in the first path bend where A=scale factor, common for the entire curve.

$$\begin{matrix}X ( 1 ) = A \cdot klot ( {M}_{1} , {s}_{1} ) * M ( {ψ}_{A} ) & ( 15 a ) \\ ψ ( 1 ) = \{ \begin{matrix}0.5 {M}_{1} \cdot {α}_{1} if {α}_{1} \leq {α}_{0} \\ 0.5 {M}_{1} \cdot {α}_{0} if {α}_{0} < {α}_{1}\end{matrix} & ( 15 b )\end{matrix}$$

Partial segment 2. Circular. Omitted if α₁≦αₒ

X(2)=A·cirk(M₁, α₁−αₒ)*M(ψ_{A}+0.5M₁·αₒ) (16a)

ψ(2)=M₁·(α₁−αₒ) (16b)

Partial segment 3. Straightening clotoid. Obtained by means of in two orthogonal directions mirroring the vector for bending clotoid from the point where the path transfers from clotoid to straight path

X(3)=A·klot(−M₁, s₁)*M(ψ_{A}+M₁·α1) (17a)

ψ(3)=ψ(1) (17b)

Partial segment 4. Straight path, zero contribution to total heading angle increment. Segment travel length=LNGD

X(4)=(LNGD, 0)*M(ψ_{A}+M₁·α₁) (18a)

Partial segment 5.

ψ(4)=0 (18b)

Partial segment 6. Bending clotoid in the second path bend

X(5)=A·klot(M₂, S₂)*M(ψ_{A}+M₁·α₁) (19a)

$$ψ ( 5 ) = \{ \begin{matrix}0.5 {M}_{2} \cdot {α}_{2} if {α}_{2} \leq {α}_{0} \\ 0.5 {M}_{2} \cdot {α}_{0} if {α}_{0} < {α}_{2}\end{matrix} \qquad ( 19 b )$$

Partial segment 7. Circular. Omitted if α₂≦αₒ

X(6)=A·cirk(M₂, α₂−αₒ)*M(ψ_{A}+M₁·α₁+0.5M₂·α₂) (20a)

ψ(6)=M₂·((α₂−αo) (20b)

Partial segment 8. Straightening clotoid. Obtained by means of in two orthogonal directions mirroring the vector for bending clotoid at the endpoint of the total path where the heading angle is ψ_{C}.

X(7)=A·klot(−M₂, s₂)*M(ψ_{C}) (21a)

ψ(7)=ψ(5) (21b)

The equation system (12), neglecting the Z-coordinate, is easily solved in the mission computer 6 by means of standard mathematical procedures for non-linear equation systems and using random start solutions in the relevant variables M₁, M₂, LNGD, α₁ and α₂. The resulting path can be used both for forwards and backwards driving.

Loading Operation Optimisation Based on the Dynamic Terrain Model and a Model of the Mechanics of the Load Handling Implement

When the report point 1211 on the dynamic approach path has been attained and loading path message 982 from the DTM-computer 82 has been received by the mission computer 6, message data is used for optimizing parameters for vehicle and implement control in the dynamic loading path 122. For this purpose is used in the optimization, both the coefficients 9821 of ground plane at the vehicle loading point 1221 and the loading height profile data list 9822 with the table z(k), k=0,1,2, . . . for terrain height at successive points along the intended loading path when penetrating the material volume 181, cf FIG. 13. Loading path depth and velocity, and bucket 142 lift and tilt movement parameters are optimized considering the requirements and constraints of filling the bucket, such as cost, minimising time of operation, minimising ground friction from bucket, minimising material spill and keeping power requirements below available power train capacity.

Groundplane Model for the Vicinity Around the Loading Point

For optimising the bucket 142 movements in the dynamic loading path 122 it is needed, for any advancement of the vehicle 1 along the intended loading path to be able to estimate a six degrees of freedom position in the fixed to ground coordinate system 41 of the fixed to vehicle coordinate system 42.

As the bucket's 142 penetration of a material volume during loading normally is limited to a rather short advancement, typically 1-3 meters, and assuming that the ground surface is relatively flat, it can be taken that a simple plane surface model for the vehicle's position in the loading path will do, and that basing the model on this assumption will not contribute to more than marginal errors in comparison with the real ground surface. A linear equation for the ground plane model in immediate vicinity of the loading point 1221 with coordinates (X_{c}, Y_{c}) can be written as:

X·X_{N}+Y·Y_{N}+Z·Z_{N}=C (22)

An estimation of the coefficients 9821 X_{N}, Y_{N} and Z_{N} and the constant C can be obtained by means of the standard method of least squares with minimum 5 representative elements in the DTM 821 for a number of points on the current best model estimation Z(3, n) of total area terrain surface in a vicinity of the vehicle loading point 1221. In the actual application, it is no difficulty to get a sufficient number of measurements for the reference ground surface in such an area. The ground plane model Eq (22) coefficient estimations are performed dynamically in the DTM-computer 82 when the vehicle 1 is on its way to the report point 1211 on the dynamic approach path 121, where the loading path message 982 based on the actual terrain model Z(1, n), n=1,2, . . . from the vehicle's current run is sent to the mission computer 6 for its optimization of the parameters 9312 for the dynamic loading path 122. The mission computer then employs these coefficients 9821 from the message 982 for obtaining, for the loading path, the vehicle's expected heading, pitch and roll angles ψ_{c}, Θ_{c}, and φ_{c}, respectively, specifically used as angular arguments of a transformation matrix M(ψ_{c}, α_{c}, φ_{c}) needed for the loading process optimization, where Eq (3) is used to convert coordinates in the fixed to vehicle coordinate system 42 to coordinates in the fixed to ground coordinate system 41. To obtain these angular arguments, the following model, in Eqs (23a), (23b), (23c) comprises the 3D vector position X(s) for a path from the loading point 1221 as a function of vehicle advancement s in the intended direction ψ_{c} and Eqs (24a), (24b), and (24c) for the corresoponding position X(r) at a lateral movement r in a perpendicular direction to the right on the same surface:

┌X(s)=X_{c}+s cos(ψ_{c}) (23a)

X(s)={Y(s)=Y_{c}+s sin(ψ_{c}) (23b)

└Z(s)=Z_{c}+s tan(Θ_{c}) (23c)

┌X(r)=X_{c}−r sin(ψ_{c}) (24a)

X(r)={Y(r)=Y_{c}+r cos(ψ_{c}) (24b)

└Z(r)=Z_{c}−r tan(φ_{c}) (24c)

Inserting (23a), (23b) and (23c) in Eq (22) gives a solution in Eq (25a) below for the angle Θ_{c}. Likewise with (24a), (24b) and (24c) gives Eq (25b) below for the angle φ_{c}.

$$\{ \begin{matrix}tan ( {ϑ}_{c} ) = - [ {X}_{N \cdot cos} ( {ψ}_{c} ) + {Y}_{N \cdot sin} ( {ψ}_{c} ) ] / {Z}_{N} & & & & & & & & ( 25 a ) \\ tan ( {ϕ}_{c} ) = - [ {X}_{N \cdot sin} ( {ψ}_{c} ) - {Y}_{N \cdot cos} ( {ψ}_{c} ) ] / {Z}_{N} & & & & & & & & ( 25 b )\end{matrix}$$

Estimated Loading Height Profile from the Attack Point 1222

Optimizing the parameters 9312 for the dynamic loading path 122 entails the parameters loading path depth, vehicle velocity and bucket 142 lift and tilt movement parameters. The optimization approach chosen in this invention is to employ the developing terrain model Z(1, n) from the vehicle's current running in conjunction with an actual best estimation Z(2, n) of the ground surface in order to be able to predict the outcome of various possible parameters for steering the vehicle and its implements. A principal idea is to keep the total model in the DTM computer 82, and only to send over relevant information for the imminent needs of the mission computer 6.

In practise, a two-dimensional height profile model of the terrain surface from the attack point 1222 along a vertical section through the linear loading path in the x/y-plane has been found to convey sufficient information for the optimization needs.

This loading height profile Z_{load}=Z_{load}(S_{g}) data list 9822 is such a model. It is approximated, cf FIG. 13, from layer 1 numbers Z(1,n), elements n belonging to a subarea of DTM 821 involving a sufficient part of the pertinent material volume 181. The height profile table Z_{load}=Z_{load}(S_{g}) represents an average of estimated terrain z-coordinates in the fixed to ground coordinate system 41, in a set of elements {nᵢⱼ, j=1,2,3, . . . , jmax} inside a rectangular area centered around the forward edge of the bucket 142, this edge being on horisontal distance s_{g}=i·d from the attack point 1222 for bucket's entry in the material volume at loading operation, and d is a suitable sampling distance between consecutive S_{g} numbers:

$${Z}_{load} ( i ) = {\sum }_{j = 1}^{j max} Z ( 1 , {n}_{i , j} ) / j max ; i = 0 , 1 , 2 , … \qquad ( 26 )$$

Determining the Bucket 142 Position in the Fixed to Ground Coordinate System 41

In a loading movement the bucket 142 starts with its blade above but close to ground and penetrates the material volume 181, at the same time as hydraulic pressure is increased on the lift cylinders 1411 in order to reduce ground friction from the weight of the bucket and its collected load. When a finishing lift can be expected to result in a full bucket, the penetration is halted. The loading movement concludes with the final lift of the bucket to get clear from the remaining material when returning with the load. A principal idea of this invention, in addition to having a good model of the material volume along the loading path, is to be able to control the bucket accurately during this movement by employing an accurate model of the bucket's geometry in a fixed to ground system as a function of vehicle advancement from vehicle loading point, and as a function of lift and tilt actuation of the load handling implement 14, as governed by a loading process sequential step variable k=0, 1, 2, . . . for controlling with good coordination each of these movements and actuations. It is also important to be able to predict the accumulated volume and weight of the pieces of material cut out from the material volume by the bucket, as well as the available bucket volume, in the various steps of a candidate loading process.

FIG. 12 shows in a section the mechanics of the load handling implement 141 and the bucket 142 and frontal parts (one wheel and part of vehicle framework) from a loading vehicle.

For a number of progressive loading process states k=0,1,2, . . . , the position of the bucket 142 can be predicted as the coordinates X(k)=[x(k), y(k), z(k)] in a fixed to ground coordinate system 41 for a number of points on the bucket geometry.

The geometry of the vehicle is in a first step determined in the fixed to vehicle coordinate system 42. In a proceeding step these local coordinates [ξ(k), η(k), ζ(k)] are transformed to a fixed to ground coordinate system 41 by the following standard transformation equation.

X(k)=X(s)+[ξ(k), η(k), ζ(k)]*M(ψ_{c}, Θ_{c}, φ_{c}), k=0,1,2, . . . , (27)

For Eq (27), it is assumed that the origo of the fixed to vehicle coordinate system is located on ground level. The transformation matrix with the arguments ψ_{c}, Θ_{c} and φ_{c} can be determined as:

$$M ( {ψ}_{c} , {ϑ}_{c} , {ϕ}_{c} ) = [ \begin{matrix}cos ϑ c cos ψ c & cos ϑ c sin ψ c & sin ϑ c \\ - cos ϕ c sin ψ c + sin ϕ c sin ϑ c cos ψ c & cos ϕ c cos ψ c ! + sin ϕ c sin ϑ c sin ψ c & - sin ϕ c cos ϑ c \\ - sin ϕ c sin ψ c - cos ϕ c sin ϑ c cos ψ c & sin ϕ c cos ψ c - cos ϕ c sin ϑ c sin ψ c & cos ϕ c cos ϑ c\end{matrix} ] \qquad ( 28 )$$

The steering angle is assumed to be zero and the local coordinate η for each point in the load handling implement can accordingly be considered to be invariant during the loading process. In order to obtain, as a function of loading process state k, the for the above transformation required local coordinates ξ(k), η(k) and ζ(k) for points on the mechanical structure of the load handling implement 14, this structure can be considered as a number of partly linked rigid mechanical elements one being the bucket 142 itself and where a hydraulic cylinder can be modeled by a pair of rigid and both limited to move along a common straight line through two cylinder attachment pivots. In order to obtain how extending or contracting the cylinders will change the position of the bucket and assuming zero steering angle the mechanical structure can be quite accurately approximated by a structure in two dimensions, ξ (forward) and ζ (upward), in the fixed to vehicle coordinate system 42. The rigid elements, consisting of planar bars and rods and the bucket represented by a polygon, are linked together by means of a number pivot axles perpendicular to the ξ/ζ-plan. Each pivot or polygon point can be represented by a unique integer from i=1 to i=imax. Cf simplified model, FIG. 13.

For each element j ε {E1, E2, . . . , E4} belongs a number of such points which, due to the rigidity of the element and independent of the position of the element have constant distance to all other points on the same element. Locally, within the set of points belonging to the rigid element j these points can be represented by integers m=0, 1, 2, . . . , mmax(j). Specifically, m=0 can be chosen to represent the center of gravity for an element and mmax(j) is the total number of pivot and polygon points in element j.

For the abovementioned points the ξ/ζ coordinates can be written as

$$\{ \begin{matrix}ξ ( j , m , k ) = ξ \text{-} coordinate , loading process state k for & & & & ( 29 a ) \\ point m in the rigid element j & & & & \\ ζ ( j , m , k ) = ζ \text{-} coordinate , loading process state k for & & & & ( 29 b ) \\ point m in the rigid element j & & & & \end{matrix}$$

Each rigid element E1, E2, . . . , E8 is required to have, for defining the element's position and orientation, at least one pivot point and one additional index point. The latter must not neccessarily be a pivot point. For these two primary points we define

Pivot point, order number m=1

Index point, order number m=2

The table below shows a choice of pivot point, index and remaining points for the simplified load handling implement's mechanical structure 141 model. Cf FIG. 12. The center of gravity points are not shown in the drawing and the bucket geometry defining points are not listed in the table.

| | | Pivot and index points | | | | | | | | |
|---|---|---|---|---|---|---|---|---|---|---|
| Elements | | 1 | 2 | 3 | 4 | 5 | 6 | 7 | 8 | 9 |
| Vehicle frame | E0 | X | X | X | | | | | | |
| Main bar | E1 | | | PIV | IND | m = 3 | m = 4 | | | |
| Rear rod | E2 | | | | | PIV | | IND | m = 3 | |
| Upper bar | E3 | | | | | | | | PIV | IND |
| Front rod & bucket | E4 | | | | | | PIV | | | IND |
| Lift cylinder, part 1 | E5 | PIV | | | | | | | | |
| Lift cylinder, part 2 | E6 | | | | PIV | | | | | |
| Tilt cylinder, part 1 | E7 | | PIV | | | | | | | |
| Tilt cylinder, part 2 | E8 | | | | | | | PIV | | |

| | | Pivot and | | | | | | | | | | | | |
|---|---|---|---|---|---|---|---|---|---|---|---|---|---|---|
| | | index points | | | Center of gravity points m = 0 | | | | | | | | | |
| Elements | | 10 | 11 | 12 | 13 | 14 | 15 | 16 | 17 | 18 | 19 | 20 | 21 | 22 |
| Vehicle frame | E0 | | | | | x | | | | | | | | |
| Main bar | E1 | | | | | | x | | | | | | | |
| Rear rod | E2 | | | | | | | x | | | | | | |
| Upper bar | E3 | | | | | | | | x | | | | | |
| Front rod & bucket | E4 | | | | | | | | | x | | | | |
| Lift cylinder, part 1 | E5 | IND | | | | | | | | | x | | | |
| Lift cylinder, part 2 | E6 | | IND | | | | | | | | | x | | |
| Tilt cylinder, part 1 | E7 | | | IND | | | | | | | | | x | |
| Tilt cylinder, part 2 | E8 | | | | IND | | | | | | | | | x |

In the two dimensional model of the mechanics 141 of the load handling implement the coordinates of the pivot and index points as functions of the extensions of the lift and tilt cylinders can now be determined by means of classic analytic plan geometry

The coordinates of the bucket 142 geometry position and orientation defining points can be determined in the same way as the already treated pivot and other points. Bu specifically employing a number of points on the inside of the bucket, the coordinates of these points can be used for determining the volume loading capacity of the bucket for any state k of the penetration and loading process. The bucket defining points can be represented by an integer number sequence of mₛₘₐₓ numbers included among the total set of numbers representing the rigid element E4 in the simplified model. Thus for bucket geometry defining points:

mₛ=1, 2, . . . , mₛₘₐₓ (30)

Employing Eq (27), the bucket defining points for each state k of the penetration and loading process can now be determined in the fixed to ground coordinate system 41 by the coordinate vector X(4, mₛ, k):

X(4, mₛ, k)=X(s)+[ξ(4, mₛ, k), η(4, mₛ, k), ζ(4, mₛ, k)]* *M(ψ_{c}, Θ_{c}, φ_{c}) (31)

As all bucket defining points can be placed in the ξ/ζ-plane of the fixed to vehicle coordinate system 42, all η(4, mₛ, k) can be set to zero in Eq (31) above.

Estimation of the Volume Loaded, for a Given Vehicle 1 and Load Handling Implement 14 Loading Path and Movement

For optimizing, in any loading cycle, vehicle 1 and load handling implement 14 loading path and movement, it is needed to have a procedure and software for estimation of the volume loaded for any given such operation. The estimation can be based on the loading height profile data list 9822 which, for successive depths S_{g}=i·d, i=0,1,2, . . . of penetration, as counted from the attack point 1222, represents an estimated height profile Z_{load}(i), i=0,1,2, . . . in fixed to ground coordinates of the material volume, as outlined above, Cf Eq (26). In a certain state k of the loading movement the edge of the bucket 142, can be expected to be located on a rather well-defined position inside the material volume. At this stage, a certain volume amount of the material volume then has been cut out by the forward edge of the bucket and been captured by the bucket. The volume amount thus cut out and captured depends on the movements and shape of the bucket and on the shape and properties of the material being loaded. Under the condition that the material being loaded is a relatively easy-running solid material, like sand, gravel or sufficiently broken down stone or other materials, the volume cut out and captured can be estimated with sufficient accuracy for each step of the loading process as a basis for an effective optimization of this process.

Let ΔVₛ(k+1) be the volume cut out between the states k and k+1 of the loading process. Assume also that, in these states, the bucket 142 has not penetrated too deep in the material volume 181. Consider a vertical cut of the material volume and oriented along the planned loading path. The near trapezoidal polygon “abcd” in FIG. 14 represents a projection on this cut of the expected volume being cut out between those two states, k and k+1 of the loading process. The upper edge “bc” of the polygon is part of a polygon through or approximating the sample points from the loading height profile data 9822. The lower edge “da” of the polygon is part of a polygon through the bucket edge in its sequential s/z plane positions according to Eq (31) [S_{g}(k), z(4, m_{g}, k)], k=0,1,2, . . . in the fixed to ground coordinate system 41. Assuming that the bucket 142 cross-section is constant over its entire width B and that the polygon can be approximated by the trapezoid “abcd” the following equation holds for ΔVₛ(k+1):

ΔVₛ(k+1)=½Bh[Zₗₐₚₚᵣ(k)+Zₗₐₚₚᵣ(k+1)−z(4, m_{g}, k)−z(4, m_{g}, k+1)] (32)

where

h=s_{g}(k+1)−S_{g}(k) (33)

and

Zₗₐₚₚᵣ(k)=[s_{g}(k)−i·d)/h]·Z_{load}(i)+{1−[s_{g}(k)−i·d)/h]}·Z_{load}(i+1) (34)

where

i·d≦s_{g}(k)<(i+1)·d (35)

and

s_{g}(k)=\sqrt{[x(4, m_{g}, k)−X_{atac}]²+[y(4, m_{g}, k)−Y_{atac}]²} (36)

Let Vₛ(k) be the total accumulated volume amount cut-out, at loading process state k of the loading process, by the bucket's edge from the material volume:

$$\{ \begin{matrix}{V}_{s} ( k ) = {\sum }_{r = 1}^{r = k} Δ {V}_{s} ( r ) , k = 1 , 2 , 3 , … ( 37 a ) \\ {V}_{s} ( 0 ) = 0 ( 37 b ) \end{matrix}$$

The bucket's 142 volume holding capacity depending on its orientation, cf FIG. 15, can be estimated from the bucket geometry and the properties of the loaded material. In an effective loading movement the flat lower plate of the bucket is initially driven into the material volume very close to the ground. During the corresponding states of the loading process it is important, in order to reduce or eliminate bucket's ground friction, to allow for sufficient hydraulic pressure in the lift cylinder circuits in order to balance the empty weight of the bucket and the rest of the load handling implement mechanical structure. At the same time, the bucket should not be allowed to rise or tilt significantly which might force a premature abortion of the penetration. Gradually, as the penetration continues, bucket load from the received material is increasing. At that stage, support reaction forces might increase acting on the bucket and causing friction. By comparing the hydraulic pressure in the lift cylinder circuits with a desired pressure considering also the expected weight of the loaded material at state k, the hydraulic pressure can be adjusted in order to facilitate the penetration by reducing friction due to support reaction forces to a minimum. Still it is important to keep the bucket low and not tilted. In this way the penetration can normally continue until the volume cut out equals the instantaneous volume holding capacity of the bucket. At this stage the penetration stops, but hydraulic pressure on the lift cylinder can now be allowed to increase further in order to lift the bucket. At the same time the tilt cylinders are engaged in order to increase the bucket holding capacity to its maximum before the bucket will raise above the upper edge of the material volume.

Bucket lift can continue until the bucket is free from the material volume. At this moment the return movement on a dynamic transport path 124 can be initiated, beginning during the first piece of the path by lowering the bucket to a low center of gravity transport position. In certain cases the conditions at penetration are such that the bucket starts to rise markedly before the desired bucket pressure can be reached. In this case the material density is probably lower than expected. The density parameter might then have to be changed. On the other hand if the material density is significantly higher than expected, the intentionally increased hydraulic pressure might not be sufficient in order to reduce friction causing slipping which also might lead to an unsuccessful loading attempt.

Estimation of Required Lift Force and Power During the Loading Path

The estimation is based on knowing, with reasonable accuracy, and for each state of the loading process, in the fixed to ground coordinate system 41, the z-coordinate and mass of each of the moving elements. By knowing this, the potential energy of the system consisting of these moving masses can also be estimated. We can also assume that the vehicle is moving on a flat but not neccessarily horisontal surface according to Eq (22). With zero friction, the dynamic process of the loading movement consumes, in any time interval, an amount of energy equal to the work needed for lifting each of these masses. By differentiating the potential energy for each of these masses as a function of the state variable k, an estimation can be made of lower bound variables for the required lift forces and power needs.

As shown above, for each state k of the loading sequence, the 3D position, in a coordinate system fixed to ground, of the main elements of the load handling implement including the bucket can be estimated with fair accuracy. This also applies to each element's center of gravity.

As the shape of the bucket is known and by using the simple assumption that the upper surface of the volume cut out by and received in the bucket is flat and horisontal, also the fixed to ground coordinates of the center of gravity of the accumulated load in the bucket can be determined with reasonable accuracy. Obviously, also the weight of all elements of the load handling implement are known and we have shown above in Eq (37) how the cut out and accumulated loaded volume Vₛ(k) can be estimated. By using an estimate of the material density, Vₛ(k) can be transformed to a weight estimation of the load in the bucket.

An Expression for the Potential Energy at Each Sequential State of a Loading Process

Exploiting the symmetry of the load handling implement 14 and bucket 142 on both sides of the ξ/ζ-plane in the fixed to vehicle coordinate system, and assuming small roll angles and roll angle motions, the two dimensional model of the load handling implement 14 and bucket 142 and the above explained concepts can also be employed for estimating volumes, weights and centers of gravity.

For state k of the loading process, let Uₘₑₖ(k) be the potential energy of the mechanical elements of the load handling implement 14 with bucket 142, and let Uₛ(k) be the potential energy of its received and accumulated load. Let U(k) be the total potential energy in state k:

U(k)=Uₘₑₖ(k)+Uₛ(k) (38)

The control dynamics allows for the load handling implement 14 to be controlled from a sequential instruction flow with constant sample time TSAMP and thus tₖ₊₁−tₖ=TSAMP invariant of k for the sampling instances t=t₁, t₂, t₃, . . . Let k(tₖ) be the desired state at t=tₖ and let ΔU(k) be the work required to bring the system from state k to state k+1:

ΔU(k)=U(k+1)−U(k) (39)

A complete loading sequence typically requires some ten seconds from attack of material volume to ready for return movement, while the sampling time TSAMP ought to be in the order of some 0.1 s or less in order to keep the system within normally acceptable error margins. Considering unavoidable model errors due to approximations regarding material density and loaded volume shape, effects of kinetic energies not considered in the models etc, we can assume the power needed to be constant during each time interval [tₖ, tₖ₊₁], k=0,1,2,3, . . . Let P(k) be the average power needed during such a time interval, and our assumption can be formulated as:

P(k)=ΔU(k)/TSAMP (40)

Eq (40) can be used for optimizing lift and tilt movement speeds in order to minimise total time for the loading process within the constraint of not exceeding available implement actuation power.

An Expression for Uₘₑₖ(k)

Let M(j) be the mass of the rigid element Ej and let Uₘₑₖ(k) be the potential energy, in a fixed to ground coordinate system 41, of the load handling implement's 14 mechanics 141 and bucket 142, but excluding the load cut out and received by the bucket:

$${U}_{mek} ( k ) = {\sum }_{j = 1}^{j max} gM ( j ) [ z ( j , 0 , k ) - z ( j , 0 , 0 ) ] \qquad ( 41 )$$

where g is the vertical acceleration of gravity

An Expression for Uₛ(k)

Let Uₛ(k) be the potential energy, in a fixed to ground coordinate system 41, of the load cut out and received by the bucket. Assume further that the center of gravity for the load is close to the center of gravity for the bucket:

Uₛ(k)=ρ·g[z(4, 0, k)−z(4, 0, 0)]Vₛ(k) (42)

Where ρ is a measure of density representing the loaded material, in kg/m³

Estimating the Magnitude of the Support Reaction Forces on Bucket

When the bucket 142 is supported by ground and has to be moved laterally, a friction force acting on the bucket and oriented as to repel the movement is excited. The strength of this friction force is proportional to the support reaction forces on bucket. By estimating the magnitude of this force F(k) as a function of loading state k, it is feasible to control the hydraulic pressure in the lift cylinder of the load handling implement in order to minimise this support reaction force and load movement repelling friction forces and instead to increase the reaction forces on the front wheels of the loading vehicle in order to improve traction and reduce the risks of slipping wheels.

The work required to work against the support reaction force an infinitesimal distance h equals the work required to lift the load handling implement with bucket and load the same distance h. Provided that the latter work can be estimated, from this equivalence the support reaction force F(k), k=1, 2, 3, . . . can be obtained.

Let F(k) be the support reaction force in a state k. The work required to move against the support reaction force an infinitesimal distance h can then be expressed as F(k)·h.

Let Δz(j,0,k)+oⱼ(h) be the positive vertical movement in the fixed to ground coordinate system 41 required for the center of gravity of element j when the bucket itself is subjected to a positive vertical movement h, corresponding to a work amount [Δz(j,0,k)+oⱼ(h)]·gM(j) for each element j. For the bucket, assuming as above that the center of gravity for the load is close to the center of gravity for the bucket, the corresponding work amount can be estimated by the expression:

ρ·g[Δz(4,0,k)+oⱼ(h)]·Vₛ(k).

From the above reasoning, F(k)·can be solved starting from the following difference equation as shown for the simplified load handling implement mechanical structure of the example in FIG. 12, with element j=4 being the front end rod with the bucket fixed to it:

$$\begin{matrix}F ( k ) \cdot h = g {\sum }_{j = 1}^{j max} [ Δ z ( j , 0 , k ) + {o}_{j} ( h ) ] \cdot M ( j ) + \\ ρ \cdot g [ Δ z ( 4 , 0 , k ) + {o}_{j} ( h ) ] \cdot {V}_{s} ( k )\end{matrix} \qquad ( 43 )$$

where lim oⱼ(h)=0· for h→0,

and, introducing the geometry derivatives [dz(j,0,kₒ)/dz(4, 0, kₒ)]; j=1, . . . ,jmax, Eq (44) results:

$$F ( k ) = g {\sum }_{j = 1}^{j max} M ( j ) [ d z ( j , 0 , {k}_{o} ) / d z ( 4 , 0 , {k}_{o} ) ] + ρ \cdot g {V}_{s} ( k ) \qquad ( 44 )$$

Balancing the Gravity of the Load Handling Implement 14 During the Loading Process

As mentioned above, friction forces can be significantly diminished if the support reaction forces on the bucket can be reduced by balancing the load handling implement through proper application of hydraulic pressure in the lift cylinders. Let F₁(k) be the force, in state k of the loading process, required to be exerted by the lift cylinder in order to balance the load handling implement including the expected gravity ρ·g Vₛ(k) cut out and received by the bucket. Assuming that the mechanical structure of the load handling implement can be considered stiff so that the work delivered by the lift cylinder can be delivered practically with no loss to relieve the support force F(k) as obtained from Eq (44), the following work equation (45) can be applied to an infinitesimal lift cylinder marginal extension Δl and the corresponding marginal movement h in the z-direction of the bucket 142,

F₁(k)·Δl=F(k)·h+o(h) (45)

and by differentiation:

F₁(k)=F(k)[dz(4, 0, k)/dl] (46)

From this force estimate, a corresponding hydraulic pressure can be derived knowing the area of the lift cylinder pistons. By including, in the vehicle and implement control data list 971, demanded lift cylinder pressure as derived from Eq (46), friction forces from support reaction can be substantially reduced and maximum weight transferred to the front driving wheels of the vehicle 1 to facilitate the part of the loading process where the bucket penetrates the material volume 181.

Obstacle Detection and Avoidance

Reliable and accurate detection functions are needed for the safety of the environment, for human safety and for protecting the vehicle itself against accidents and damage due to collisions or maneouvers out of controlled paths, zones and enclosures. A system for obstacle detection requires sensors for detecting and recording occurring obstacles, at least their shape and position. This data must then be stored in a systematic manner, for allowing analysis and warning or emergency action based on the currently relevant collected obstacle data as well as regarding the vehicle's 1 actual shape and current and its nearest planned or predicted continued path. Primarily an object of a certain minimum size such as height appearing inside an obstacle free zone 191 as defined in the DTM 821 can be considered to be an obstacle. It can also be the purpose of an obstacle detection system to check the vehicle's actual position and its path so that it does not, neither is predicted to, enter any area not inside any obstacle free, loading or unloading zone.

From a point the vehicle 1 can be associated with a number of zones in a fixed to vehicle coordinate system. A first such zone can be the nearest environment around the vehicle where detection and occurrence of an obstacle requires immediate emergency stop. A second such zone can be an additional zone around the vehicle, but outside the first zone. Detection and occurrence of an obstacle in this second zone might only require a warning or/and a slowdown action. The size and number of such zones depends on the vehicle's speed, maneouvering capability, braking distance and the range of the obstacle detection system. Data regarding these zones can be conveyed in the mission instructions 9 in the form of zone, inner and outer, border polygon list 9521 and 9522, respectively. During operation, the DTM-computer 82 can employ this data together with from mission computer 6 obtained vehicle and implement control data list 971 for evaluating criteria based on data in the DTM 821 for warning or emergency action at occurrence of obstacle inside zone both related to the current position of the vehicle as its planned and predicted path according to the current vehicle and implement control data list.

In preparation of each path, both the vehicle control computer 211 and the DTM-computer 82 receive a vehicle and implement control data list 971. In the DTM-computer an obstacle avoidance mapping 1955 in fixed to ground coordinates can be produced from projecting the fixed to vehicle obstacle avoidance zones on the fixed to ground coordinate system 41 for each position of the vehicle in its imminent path according to the vehicle and implement control data list 971. This obstacle avoidance mapping 1955 can be considered as a set of elements in the DTM 821 being the union set of all elements occupied by some area from any of the projected vehicle obstacle avoidance zones on the fixed to ground coordinate system. Cf FIG. 18. This enables an initial check before starting the vehicle in the path that this path will keep the vehicle well inside the allowed obstacle free, loading and unloading zones. When the vehicle is underway on its path, the DTM computer constantly checks if any obstacle appears at any element of the DTM which is covered by any area from any of the vehicle's obstacle avoidance zones as projected on the fixed to ground coordinate system for the actual position of the vehicle. Let P(K, L) be points and let χ(K, L)=[ξ(K, L), η(K, L), ζ(K,L)] be the corresponding coordinate vectors in a three dimension coordinate table of the fixed to vehicle coordinate system 42 where the points P(K, L) represent the vehicle's obstacle avoidance geometry 195 and for each of the levels L=1, 2, . . . , LMAX consists of a fixed to vehicle obstacle avoidance zone A(L), 1951, contained within a closed border polygon ω(L) 1952 with its corners being the points P(K, L) for K=1, 2, 3, . . . , KMAX.

Let X(s)=[X(s), Y(s), Z(s)] be coordinates and ψ(s), Θ(s), φ(s) be heading, pitch and roll angles in the fixed to ground coordinate system 41 for the fixed to vehicle coordinate system 42 in a point P₍ₛ₎ located on a distance s—sₒ along the vehicle's planned path from its current position with its coordinates X₍ₛₒ), where this vehicle path is defined by a vehicle and implement control data list 971 from the mission computer 6. Let A(L, u) be an obstacle avoidance zone projection 1954 on level L of the fixed to vehicle obstacle avoidance zone A(L) on the DTM 821 in the fixed to ground coordinate system, where this zone A(L, u) is contained within a closed border polygon Ω(L,u), 1953, as defined by points P(K, L, u), and their corresponding coordinate vectors X(K, L, u)=[X(K, L, u), Y(K, L, u), Z(K, L, u)], K=1, 2, . . . , KMAX and where each such point P(K, L, u) is a projection on the DTM in the fixed to ground coordinate system 41 of the point p(K, L) with the coordinate vector χ(K, L)=[ξ(K, L), η(K, L), ζ(K,L)] belonging to the border polygon ω(L) in the fixed to vehicle coordinate system 42. Finally, a fixed to ground obstacle avoidance mapping 1955 is made up as the union set Θ(L,s) of all obstacle avoidance zone projections A(L, u) from the vehicle's different positions “u” along its path, sₒ≦u≦s.

Four steps to obtain the fixed to ground obstacle avoidance mapping 1955:

1° Let P(K, L, u) be the projection on DTM 821 in fixed to ground coordinate system 41 of the 3D coordinate point P(K, L) in the fixed to vehicle coordinate system 42. Let P(K, L, u) have the coordinate vector X(K, L, u)=X(K, L, u), Y(K, L, u), and Z(K, L, u)]. This vector can be obtained from Eq (47) below, where X(u), Y(u) and ψ(u) are, in the fixed to ground coordinate system 41, 2D position coordinates and heading angle, respectively, for the fixed to ground coordinate system 42 according to vehicle and implement control data list 971:

X(K, L, u)=X(u)+χ(K, L)*M[ψ(u), Θ(u), φ(u)] (47)

the matrix M is defined in Eq (2) and the pitch and roll angles can be estimated from the DTM from the Z-coordinates of a number of elements in DTM around the element occupied by [X(u), Y(u)] and by using a standard least squares estimation like the one employed for finding Eq (22) coefficients, X_{N} and Y_{N}. From thus estimated X_{N} and Y_{N} for the point on [X(u), Y(u)], Θ(u) and φ(u) can be obtained from the equations (25a) and (25b).

The Z-coordinate can be obtained directly from Eq (22) as Z(u)=[C(u)−X(u) X_{N}(u)−Y(u) Y_{N}(u)]/Z_{N}(u).

2° The polygon Ω(L,s) is made up by X and Y coordinate points from the coordinate vector X(K, L, u), K=1, 2, . . . , KMAX.

3° The obstacle avoidance zone projection 1954 A(L,u), is the surface within the closed polygon Ω(L,u). Elements of the DTM with some area inside the Ω(L,u) are considered to belong to this zone projection.

4° A fixed to ground obstacle avoidance mapping 1955 is represented by the union set Θ(L,s):

$$Θ ( L , s ) = {{⋃}_{u = {s}_{o}}}^{u = s} A ( L , u ) \qquad ( 48 )$$

The obstacle avoidance assignment of the DTM-computer 82 is, with a predetermined rate to analyse the DTM 821 inside areas Θ(L,s), L=1, . . . ,LMAX, and carry out those actions possibly following the obstacle avoidance analysis according to the criteria listed below. In addition, for each new vehicle and implement control data list 971 the DTM has to evaluate it according to the criteria below for possible conflicts with established obstacle free loading and unloading zones.

1° If, for any element in DTM Z(4, n)=1 and this element is also within Θ(L,sₒ), but given threshold value H is exceeded by H≦Z(1, n)−Z(2, n) for this element, then there is at least one element of DTM within level number L of the fixed to ground obstacle avoidance mapping 1955 that has to be considered as an obstacle requiring obstacle avoidance action with message number H(0, L).

2° If, for any element in DTM Z(4, n),Z(5, n) and Z(6 n) all are zero and if this element also is within Θ(L,sₒ), at least one point of the fixed to ground obstacle avoidance mapping 1955 number L is not located inside any of the obstacle free, loading or unloading zones. This event requires obstacle avoidance action with message number H(0, L).

3° If, for any element in DTM Z(4, n)=1 and this element is also within Θ(L,sₒ), but given threshold value H is exceeded by H≦Z(1, n)−Z(2, n) for this element, then there is at least one element of DTM within level number L of the fixed to ground obstacle avoidance mapping 1955 that has to be considered as an obstacle in the planned path requiring obstacle avoidance action with message number H(1, L).

4° If, for any element in DTM Z(4, n),Z(5, n) and Z(6 n) all are zero and if this element also is within Θ(L,s), at least one point of the fixed to ground obstacle avoidance mapping 1955 number L is not located inside any of the obstacle free, loading or unloading zones. This event has to be considered as a cause for rejecting the planned path requiring obstacle avoidance action with message number H(1, L).

Obstacle avoidance messages from the DTM-computer at an inner obstacle avoidance geometry J=1 and an outer obstacle avoidance geometry J=2:

H(0, 1): Emergency stop message 9841 to the vehicle control computer 211

H(0, 2): Warning message 9842 to the vehicle control computer 211

H(1, 1): Rejection of planned path in revision message 980 to the mission computer 6

H(1, 2): Warning message 9842 to the vehicle control computer 211.

Other aspects, objects and advantages of the present invention can be obtained from a study of the drawings, the disclosure and the appended claims.

What we claim as our invention is:

1. A set of methods, functions and apparatus for bulk and other general material handling such as loading, unloading, and transportation by mobile robots in the form of autonomous vehicles and machines, for industrial applications in limited areas and fields, outdoor as well as indoor or underground, comprising:
a method with one or more loading zones as the only kind of areas from which loading and its constituent material volume penetration by the vehicle's bucket is allowed, one or more unloading zones as the only kind of areas to which unloading and its constituent bucket emptying is allowed, and one or more obstacle free zones which, together with loading and unloading zones, are the only kind of areas where autonomous navigation and vehicle implement movements are allowed;
a method with a reference ground surface supporting material volumes and other general handling objects, where such a surface, specifically in the loading, unloading and obstacle free zones is accurately defined, in a fixed to ground coordinate system, by x, y and z-coordinates for ordered surface points, and used as reference for comparisons with current measurements of the surface of stored material volumes and other general handling objects thereon, and where this data is employed for accurate vehicle path and vehicle and implement motion parameter optimization at loading and unloading operations;
a position determination system for accurately determining, in real time, outdoor as well as indoor or underground, the three-dimensional position x, y, and z and the three attitude angles heading, pitch and roll, of a fixed to vehicle coordinate system, in a fixed to ground coordinate system, where this position determination system can be a laser-optic system where the position is determined by means of azimuth and elevation angle measurements, with an on-board vehicle located rotating laser-optic sensor, in the fixed to vehicle coordinate system, to a number of reflectors with known coordinates in the fixed to ground coordinate system;
a terrain surface measuring system for determining, in real time, the three-dimensional position of points on the terrain surface in a fixed to ground coordinate system, where the position of each such point can be determined by means of azimuth angle and range measurements in a fixed to vehicle coordinate system by at least one on-board vehicle located scanning laser rangefinder, and coordinate transformation of such measurements employing the six degrees of freedom position data in fixed to ground coordinates from the position determination system;
a dynamic terrain model for collecting, processing and updating terrain surface data employed for optimizing vehicle path and vehicle and bucket movement parameters in loading and unloading operations by measuring the location and shape of material volumes and obstacles, where this model has at least three essential layers: 1) developing model based on measurements from the current path with the laser-optic terrain surface measuring system, 2) best estimate of reference ground surface based on geodetic data or earlier runs with the system over the actual terrain and 3) the best estimate of the terrain surface of the total worksite attainable by the system, where this dynamic terrain model is analysed for determining attack, and bucket emptying points, and the position of the vehicle at loading and unloading, respectively, and also a loading height profile of the material volume along the loading path in a loading operation;
a mission computer provided with software for optimizing dynamic vehicle paths and the movements of vehicle and load handling implement during loading and unloading operations based on attack, bucket emptying, loading and unloading points and loading height profile data from the dynamic terrain model, and with mission instructions comprising data for defining obstacle free, loading and unloading zones, parameters for static and dynamic transportation paths, reconnaissance paths, loading paths and unloading movements and mission programs for selecting and linking paths and for generating detailed vehicle and implement control data lists for low level vehicle control based on the current vehicle path and vehicle and implement movement parameters;
a vehicle control computer for low level vehicle control based on a vehicle and implement control data list from the mission computer, and provided with interfaces to the sensors and actuators as needed for controlling the vehicle and its implements.

2. A set of methods, functions and apparatus as set forth in claim 1 wherein the dynamic terrain model also is used for evaluating planned paths and for obstacle detection in order to avoid the vehicle running into obstacles or outside the specific areas devoted for autonomous navigation, comprising:
a layer in the dynamic terrain model for indicating obstacle free terrain elements;
a method to classify an element No. n in the dynamic terrain model as representing a not obstacle-free part of the terrain by comparing Z(1,n) of the developing model layer in the dynamic terrain model with the a priori best estimate Z(3,n) of the terrain surface layer, if H<Z(1,n)−Z(3,n) where H is a given maximum obstacle height;
a method for evaluating planned paths concerning the risk of the vehicle for stepping outside the specific areas devoted for autonomous navigation, in order to detect possible planning errors by testing, for all elements n of the dynamic terrain model representing points in each obstacle avoidance mapping for the vehicle's planned path, if such a point not is inside any of the loading, unloading or obstacle free zones, then the planned path is rejected, where;
a number of vehicle obstacle avoidance zones are defined in a fixed to vehicle coordinate system;
a specific obstacle avoidance action can be assigned to a vehicle obstacle avoidance zone;
obstacle avoidance zone projection is a momentarily defined area in a fixed to ground coordinate system where this area constitutes the projection in the horisontal plane of a fixed to vehicle obstacle avoidance zone for one specific position of the vehicle in its path;
obstacle avoidance mapping in fixed to ground coordinates is a union set of obstacle avoidance zone projections for a sequence of positions of the vehicle in its path;
a method, for obstacle avoidance action, based on the presence of a non obstacle-free terrain element No. n of the dynamic terrain model inside any vehicle obstacle avoidance zone projection for the vehicle's present position, to cause an alarm specific to the kind of action relevant for this obstacle avoidance zone projection.
a method, for obstacle avoidance action, based on the presence of a non obstacle-free terrain element No. n of the dynamic terrain model inside any obstacle avoidance mapping representing the vehicle's planned path, from the vehicle's present position, to cause an alarm specific to the kind of action relevant for this obstacle avoidance mapping;

3. A set of methods, functions and apparatus as set forth in claim 1 wherein the dynamic terrain model also is used for optimizing parameters for controlling the vehicle's path and the vehicle's and the load handling implement's movements when approaching and penetrating a material volume in a loading operation, comprising:
a method to select an attack point for the bucket's entry in a material volume at the coordinates of the nearest terrain element n to a line in front of, and parallell with, the intended front of the material volume where on this element the material volume height Z(1 ,n)−Z(2,n) exceeds a given value A;
a method to optimize the loading operation in the form of vehicle path and bucket movement parameters at the outset of a loading operation by estimating loaded volume as a function of penetration depth and bucket lift and tilt movement parameters and thereby, from a loading height profile of the current terrain surface defined for a number of points i=1, 2, 3, . . . along the planned loading path, where the Z-coordinate Z_{load}(i) in a fixed to ground coordinate system for each such point No. i represents an average of Z(1,n) for points n in a representative to the bucket width neighbourhood of such point No. i from the developing model layer of the dynamic terrain model, where this loaded volume is calculated as the volume cut out by the bucket for a succession of positions, in the same fixed to ground coordinate system, of the vehicle and the bucket for given movement parameters of vehicle and bucket movement;
a method to reduce friction caused by reaction forces from ground acting on the bucket, in the bucket's penetration of a material volume by optimizing the hydraulic pressure to the bucket lift and tilt cylinders based on an estimate of the total weight and momentum of the load handling implement with its bucket and its loaded volume as a function of penetration depth and bucket lift and tilt movement parameters.
